(19) United States
(12) Patent Application Publication
(10) Pub. No.: US 2025/0389655 A1
(43) Pub. Date: Dec. 25, 2025

(54) SPECTROSCOPIC CHARACTERIZATION METHODS FOR SUPPORTED MULTI-COMPONENT CATALYST

(71) Applicants: ExxonMobil Chemical Patents, Inc., Baytown, TX (US); Texas Christian University, Fort Worth, TX (US)

(72) Inventors: Xuan Ye, Baytown, TX (US); Christopher S. Breiner, Baytown, TX (US); Charles J. Harlan, Baytown, TX (US); Jonathan J. Schaefer, Baytown, TX (US); Zygmunt Gryczynski, Fort Worth, TX (US); Luca Ceresa, Fort Worth, TX (US); Joseph Kimball, Fort Worth, TX (US)

(73) Assignees: ExxonMobil Chemical Patents Inc., Baytown, TX (US); Texas Christian University, Fort Worth, TX (US)

(21) Appl. No.: 18/874,019

(22) PCT Filed: Jul. 12, 2023
(86) PCT No.: PCT/US23/27544

§ 371 Date: Dec. 11, 2024

Related U.S. Application Data
(60) Provisional application No. 63/398,065, filed on Aug. 15, 2022.

(51) Int. Cl. G01N 21/64; G01N 21/49; G01N 21/85

(52) U.S. Cl. CPC G01N 21/6402; G01N 21/49; G01N 21/6408; G01N 21/8507; G01N 2021/6421

(57) ABSTRACT

A variety of methods are disclosed, including, in one embodiment, preparing a slurry catalyst mixture comprising a multi-modal catalyst and a carrier fluid, wherein the multi-modal catalyst comprises a first activated catalyst and a second activated catalyst; introducing the slurry catalyst mixture into a sample chamber; illuminating the slurry catalyst mixture in the sample chamber with light generated from a light source; capturing a spectrum of the slurry catalyst mixture using a detector, wherein the spectrum comprises at least one spectrum selected from the group consisting of UV-Vis spectrum, emission spectrum, and combinations thereof; and determining a calculated ratio of an amount of the first activated catalyst and an amount of the second activated catalyst in the multi-modal catalyst from the spectrum of the slurry catalyst mixture by fitting the spectrum of the slurry catalyst mixture to a single component spectrum of the first activated catalyst and a single component spectrum of the second activated catalyst, using spectral deconvolution.

### FIELD

This disclosure relates to catalyst slurry mixtures. In particular, this disclosure relates to spectroscopic characterization methods for making catalyst slurry mixtures, and real-time monitoring/controlling of the process.

### BACKGROUND

Supported multi-component catalysts are widely used in commercial scale polymer production as multi-component catalysts enable the production of multi-modal polymer resins. Supported dual-component catalysts include a support with two types of active sites disposed thereon. The relative contribution to polymerization between the first and second active sites determines the composition of the resulting multi-modal polymer resin, where the relative contribution of each active site is dependent upon the ratio of the active sites on the supported dual-component catalyst.

A method of producing a supported dual-component catalyst may include reacting a first catalyst component containing a precursor for the first type of active site and a second catalyst component containing a precursor for the second type of active site at conditions suitable to transform at least a portion of the precursor of the first and second type of active site to the activated form. The mole ratio of the two types of active sites does not necessarily equal the mole ratio of the two precursors used in the preparation of the supported catalyst. There are likely several reasons for the disparity, including that the two precursors may have different activation energies, and sometimes referred to as activation efficiency, thereby leading to a disparate activation for the two catalyst precursors used during the catalyst preparation. Even if the mole ratio of the two catalyst precursors is kept constant during catalyst production, the mole ratio of the resulting two types of active sites on the supported catalyst may vary due to variability in relative activation energy in catalyst preparation.

Further, at present there is no analytical technique which can directly probe the ratio of the two types of active sites on the supported catalyst. The ratio of the active sites can be indirectly evaluated by a polymerization test such as in a pilot plant or lab-scale reactor followed by analysis of the resultant polymer. However, this technique is time consuming and does not allow for feedback to a catalyst production process or a commercial polymer production process. Without knowledge of the ratio of the active sites in the dual-component catalyst, it is generally not possible to determine the composition of the polymer resin product in advance of using the dual-component catalyst. Ideally, the dual-component catalyst would be characterized to determine the ratio of active sites in advance of using the dual-component catalyst in a polymerization application such that the catalyst response in the reactor as well as the composition of the resin product can be more readily controlled.

References of potential interest in this regard include: U.S. Pat. Nos. 6,194,223; 6,723,804; 7,456,021; 7,904,271; 8,843,324; 10,679,734; and 11,170,874; as well as EP1713840, EP3071950, EP3655756, WO2014/062643; Babushkin, Dmitrii et al., “Novel Zirconocene Hydride Complexes in Homogeneous and in SiO2-Supported Olefin-Polymerization Catalysts Modified with Diisobutylaluminum Hydride or Triisobutylaluminum,” Macromolecular Chemistry and Physics 209 (12), 1210-1219 (2008); and Velthoen, Marjolein et al., “Insights into the activation of silica-supported metallocene olefin n polymerization catalysts by methylaluminoxane”, Catalysis Today 334, 223-230 (2019).

### SUMMARY

Disclosed herein is an example method comprising: preparing a slurry catalyst mixture comprising a multi-modal catalyst and a carrier fluid, wherein the multi-modal catalyst comprises a first activated catalyst and a second activated catalyst; introducing the slurry catalyst mixture into a sample chamber; illuminating the slurry catalyst mixture in the sample chamber with light generated from a light source; capturing a spectrum of the slurry catalyst mixture using a detector, wherein the spectrum comprises at least one spectrum selected from the group consisting of UV-Vis spectrum, emission spectrum, and combinations thereof; and determining a calculated ratio of an amount of the first activated catalyst to an amount of the second activated catalyst in the multi-modal catalyst from the spectrum of the slurry catalyst mixture by fitting the spectrum of the slurry catalyst mixture to a single component spectrum of the first activated catalyst and a single component spectrum of the second activated catalyst, using spectral deconvolution.

Further disclosed herein is a method comprising: providing an optical probe, the optical probe comprising a light source, a detector, and an optic fiber, wherein the optic fiber is configured to transmit light emitted from the light source to a sample chamber and wherein the optic fiber is further configured to transmit light from the sample chamber to the detector; preparing a slurry catalyst mixture comprising a multi-modal catalyst and a carrier fluid, wherein the multi-modal catalyst comprises a first activated catalyst and a second activated catalyst; continuously feeding the slurry catalyst mixture into the sample chamber; illuminating the slurry catalyst mixture in the sample chamber with light generated from the light source, while continuously feeding the slurry catalyst mixture into the sample chamber; capturing a spectrum of the continuously fed slurry catalyst mixture using a detector, wherein the spectrum comprises at least one spectrum selected from the group consisting of UV-Vis spectrum, emission spectrum, and combinations thereof; and determining a calculated ratio of an amount of the first activated catalyst and an amount of the second activated catalyst in the multi-modal catalyst from the spectrum of the slurry catalyst mixture by fitting the spectrum of the slurry catalyst mixture to a single component spectrum of the first activated catalyst and a single component spectrum of the second activated catalyst, using spectral deconvolution

Further disclosed herein is method comprising: contacting a base catalyst mixture and a trim catalyst solution to form a contact product comprising a post-trim multimodal catalyst, wherein the base catalyst mixture comprises a first catalyst, a second catalyst, a support, an activator, and a carrier, wherein the trim catalyst solution comprises additional second catalyst, and a solvent, and wherein the post-trim bimodal catalyst comprises a first active catalyst corresponding to the first catalyst and a second active catalyst corresponding to the second catalyst; generating a spectrum of the post-trim multimodal catalyst; determining a calculated ratio of an amount of the first active catalyst to an amount of the second active catalyst in the post-trim multimodal catalyst from the spectrum of the post-trim multimodal catalyst by fitting the spectrum of the post-trim multimodal catalyst to a single component spectrum of the first active catalyst and a single component spectrum of the second active catalyst using spectral deconvolution; comparing the calculated ratio to a target ratio of the first active catalyst to the second active catalyst in the post-trim multimodal catalyst and adjusting a flow rate of the trim catalyst solution such that the calculated ratio of amount of the first active catalyst and the second active catalyst in the post-trim multimodal catalyst is closer to the target ratio; introducing the post-trim multimodal catalyst and one or more olefins into a polymerization reactor; and polymerizing the one or more olefins in the presence of the post-trim multimodal catalyst to produce a polymer product.

Further disclosed herein is a system comprising: a sample chamber configured to hold a post-trim multimodal catalyst mixture, wherein the post-trim multimodal catalyst mixture comprises a first activated catalyst and a second activated catalyst, wherein the post-trim multimodal catalyst mixture is produced by contacting a base catalyst mixture and a trim catalyst solution to form a contact product comprising a post-trim multimodal catalyst, wherein the base catalyst mixture comprises a first catalyst, a second catalyst, a support, an activator, and a carrier, wherein the trim catalyst solution comprises additional second catalyst, and a solvent, and wherein the post-trim bimodal catalyst comprises a first active catalyst corresponding to the first catalyst and a second active catalyst corresponding to the second catalyst; an optical probe configured to illuminate the post-trim multimodal catalyst mixture in the sample chamber and generate a spectrum of the post-trim multimodal catalyst mixture; and a control system configured to: receive the spectrum; determine a calculated ratio of an amount of the first activated catalyst and the second activated catalyst in the post-trim multimodal catalyst mixture from the spectrum of the post-trim multimodal catalyst mixture by fitting the spectrum of the post-trim multimodal catalyst mixture to a single component spectrum of the first activated catalyst and a single component spectrum of the second activated catalyst using spectral deconvolution; compare the calculated ratio of the amount of the first activated catalyst and the second activated catalyst in the multimodal catalyst to a set point ratio of the amount of the first activated catalyst and the second activated catalyst in the multimodal catalyst; and adjust a flow rate of a trim catalyst solution such that the calculated ratio of amount of the first active catalyst and the second active catalyst in the post-trim multimodal catalyst is closer to the set point ratio

These and other features and attributes of the disclosed methods and systems of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings, wherein:

FIG. 1 is a schematic of a gas-phase reactor system in accordance with certain embodiments of the present disclosure.

FIG. 2A illustrates an example method of producing a dual-component catalyst and using the dual-component catalyst in a production of a multi-modal polymer in accordance with certain embodiments of the present disclosure.

FIG. 2B illustrates the contribution of active sites of a dual-component catalyst in accordance with certain embodiments of the present disclosure.

FIG. 2C illustrates the preparation of a dual-component catalyst and the ratio of the two types of activated sites on the dual-component catalyst in accordance with certain embodiments of the present disclosure.

FIG. 3A illustrates a production scheme for a post-trim catalyst in accordance with certain embodiments of the present disclosure.

FIG. 3B illustrates the relative ratio of the two types of active sites in a post-trim catalyst in accordance with certain embodiments of the present disclosure.

FIG. 4 illustrates a scheme for spectral deconvolution of a UV-Vis spectrum, or a steady-state fluorescence emission spectrum, or a time-resolved emission spectrum of a supported dual component catalyst in accordance with certain embodiments of the present disclosure.

FIG. 5 is an example optical probe for in-line measurement of a post-trim multi-component catalyst in accordance with certain embodiments of the present disclosure.

FIG. 6A is a schematic illustration of an optical probe in accordance with certain embodiments of the present disclosure.

FIG. 6B is a schematic illustration of an optical probe in accordance with certain embodiments of the present disclosure.

FIG. 6C is a schematic illustration of an optical probe in accordance with certain embodiments of the present disclosure.

FIG. 6D is a schematic illustration of a reactor system including an optical probe in accordance with certain embodiments of the present disclosure.

FIG. 7A is the as-measured UV-Vis spectra of catalysts prepared in accordance with certain embodiments of the present disclosure.

FIG. 7B is the normalized UV-Vis spectra of catalysts prepared in accordance with certain embodiments of the present disclosure.

FIG. 7C is a fitted UV-Vis spectrum (with 3-component fitting) of catalyst prepared in accordance with certain embodiments of the present disclosure.

FIG. 8A is the corrected and normalized UV-Vis spectra of catalysts prepared in accordance with certain embodiments of the present disclosure.

FIG. 8B is a fitted UV-Vis spectrum (with 2-component fitting) of catalyst prepared in accordance with certain embodiments of the present disclosure.

FIG. 9A is a plot of the % of spectrum for activated catalyst precursor A via 3-component fitting versus the % of spectrum for activated catalyst precursor A via 2-component fitting in accordance with certain embodiments of the present disclosure.

FIG. 9B is a plot of the mol % of catalyst precursor A used in the preparation of dual-component catalyst versus the % of spectrum for activated catalyst precursor A via 3-component fitting in accordance with certain embodiments of the present disclosure.

FIG. 10A is a graph of the % UV-Vis spectrum of activated precursor 1 vs. the resin MIR observed in a pilot plant testing of the corresponding catalyst in accordance with certain embodiments of the present disclosure.

FIG. 10B is a graph of the % UV-Vis spectrum of activated precursor 1 vs. the end-of-run H2/C2 gas ratio observed in a lab batch reactor testing of the corresponding catalyst in accordance with certain embodiments of the present disclosure.

FIG. 11A is the as-measured steady-state emission spectra (with 405 nm Excitation) of catalysts prepared in accordance with certain embodiments of the present disclosure.

FIG. 11B is the normalized steady-state emission spectra (with 405 nm Excitation) of catalysts prepared in accordance with certain embodiments of the present disclosure.

FIG. 11C is a fitted steady-state emission spectrum (with 3-component fitting) of a catalyst in accordance with certain embodiments of the present disclosure.

FIG. 12A is the as-measured steady-state emission spectra (with 485 nm Excitation) of catalysts in accordance with certain embodiments of the present disclosure.

FIG. 12B is the normalized steady-state emission spectra (with 485 nm Excitation) of catalysts in accordance with certain embodiments of the present disclosure.

FIG. 12C is a fitted steady-state emission spectrum (with 2-component fitting) of a catalyst in accordance with certain embodiments of the present disclosure.

FIG. 13A is a graph of the % steady-state emission spectrum of an activated catalyst precursor A via 3-component fitting versus resin MIR observed in a pilot plant testing of the corresponding catalyst in accordance with certain embodiments of the present disclosure.

FIG. 13B is a graph of the % steady-state emission spectrum of an activated catalyst precursor A via 3-component fitting versus the end-of-run H2/C2 gas ratio observed in a lab batch reactor testing in accordance with certain embodiments of the present disclosure.

FIG. 13C is a graph of the % steady-state emission spectrum of an activated catalyst precursor A via 2-component fitting versus resin MIR observed in a pilot plant testing of the corresponding catalyst in accordance with certain embodiments of the present disclosure.

FIG. 13D is a graph of the % steady-state emission spectrum of an activated catalyst precursor A via 2-component fitting versus the end-of-run H2/C2 gas ratio observed in a lab batch reactor testing in accordance with certain embodiments of the present disclosure.

FIG. 14A is a schematic illustration of the production of a post-trim bi-modal catalyst in accordance with certain embodiments of the present disclosure.

FIG. 14B is the normalized UV-Vis spectra of a base catalyst and a post-trim catalyst in accordance with certain embodiments of the present disclosure.

FIG. 14C is a plot of the % UV-Vis spectrum of an activated catalyst precursor A in a post-trim bi-modal catalyst versus resin MIR observed in a pilot plant testing of the corresponding catalyst in accordance with certain embodiments of the present disclosure.

FIG. 15A is an as-measured UV-Vis spectrum of a catalyst slurry mixture and an as-measured UV-Vis spectrum of the carrier fluid obtained with optical probe in accordance with certain embodiments of the present disclosure.

FIG. 15B is a normalized UV-Vis spectrum of a catalyst slurry mixture obtained with optical probe, and a normalized UV-Vis spectrum of the same catalyst slurry mixture obtained with standard spectrometer in accordance with certain embodiments of the present disclosure.

FIG. 16 illustrates the preparation of a control sample series comprising a scatter carrier, Uranin dye, and RhB dye in accordance with certain embodiments of the present disclosure.

FIG. 17A is the as-measured steady-state emission spectra (with optical probe in front face configuration) of scatter carrier, Uranin in carrier, RhB in carrier, and a mix of Uranin and RhB in carrier in accordance with certain embodiments of the present disclosure.

FIG. 17B is a fitted spectrum of the mix of Uranin and RhB in carrier using 3-component fitting in accordance with certain embodiments of the present disclosure.

FIG. 18 illustrates the correlation between the Vol % of RhB in scatter in the mix of Uranin and RhB in scatter with the % spectrum of RhB in scatter obtained through 3-component linear deconvolution in accordance with certain embodiments of the present disclosure.

FIG. 19 is an example of fluorescence emission intensity decay of C₁₅₃ dye obtained in front face configuration with an optical probe coupled with a 440 nm pulsed laser light source in accordance with certain embodiments of the present disclosure.

### DETAILED DESCRIPTION

Disclosed herein are methods of spectroscopic characterization methods for supported catalyst in slurry. Gas-phase polymerization in a fluidized bed is an industrial process used in polymerizing ethylene and ethylene comonomers to produce polyethylene polymer and copolymer compositions. It is generally known in the art that a polyolefin's composition distribution (CD) and molecular weight distribution (MWD) affect attributes of the polyolefin. To reduce or to avoid certain trade-offs among desirable attributes, bimodal polymers have become increasingly important in the polyolefins industry. Catalyst design and support technology have allowed for the development of single-reactor bimetallic (dual component) catalyst systems capable of producing bimodal polyethylene. The active sites' composition (i.e., the mole ratio of the two types of active sites) in dual-component catalyst system, often differs from the mole ratio of the two catalyst precursor used in making the dual-component catalyst. The evaluation of the active sites' composition of a dual-component catalyst has relied on polymerization testing, as no analytical method offers a direct assessment of the active sites' ratio of the catalyst.

A supported catalyst is added to a diluent to form a catalyst slurry and pumped to a polymerization reactor. A catalyst solution can be added (i.e., “trimmed”) to the catalyst slurry to adjust one or more properties “in-situ” of polymer being formed in a reactor. However, such “trim” processes are limited because the post-trim catalyst is typically not characterized before introduction into the polymerization reactor, as described above. As will be disclosed in further detail below, an in-line spectral measurement using an optical probe allows for measurements of UV-Vis absorption, steady-state emission spectra (SS-EMS), time-resolved emission spectra, and lifetime measurement of supported dual-component catalyst to characterize the post-trim catalyst and provide more precise process control.

As used herein, the indefinite article “a” or “an” shall mean “at least one” unless specified to the contrary or the context clearly indicates otherwise. Thus, embodiments using “an alpha-olefin” include embodiments where one, two or more alpha-olefins are used, unless specified to the contrary or the context clearly indicates that only one alpha-olefin is used.

As used herein, “wt. %” means percentage by weight, “vol %” means percentage by volume, “mol %” means percentage by mole, “ppm” means parts per million, and “ppm wt” and “wppm” are used interchangeably and mean parts per million on a weight basis. All concentrations herein, unless otherwise stated, are expressed on the basis of the total amount of the composition in question.

An “olefin” is a linear, branched, or cyclic compound of carbon and hydrogen having at least one double bond. For purposes of this specification and the claims appended thereto, when a polymer or copolymer is referred to as including an olefin, e.g., ethylene and at least one C₃ to C₂₀ α-olefin, the olefin present in such polymer or copolymer is the polymerized form of the olefin. For example, when a copolymer is said to have an “ethylene” content of 35 wt. % to 55 wt. %, it is understood that the repeating unit/mer unit or simply unit in the copolymer is derived from ethylene in the polymerization reaction and the derived units are present at 35 wt. % to 55 wt. %, based on a weight of the copolymer. For the purposes of the present disclosure, ethylene shall be considered an α-olefin.

A “polymer” has two or more of the same or different repeating units/mer units or simply units. A “homopolymer” is a polymer having units that are the same. A “copolymer” is a polymer having two or more units that are different from each other. A “terpolymer” is a polymer having three units that are different from each other. The term “different” as used to refer to units indicates that the units differ from each other by at least one atom or are different isomerically. The definition of copolymer, as used herein, includes terpolymers and the like. Likewise, the definition of polymer, as used herein, includes homopolymers, copolymers, and the like. Furthermore, the terms “polyethylene copolymer”, “ethylene copolymer”, and “ethylene-based polymer” are used interchangeably to refer to a copolymer that includes at least 50 mol % of units derived from ethylene.

Nomenclature of elements and groups thereof used herein are pursuant to the NEW NOTATION published in HAWLEYS CONDENSED CHEMICAL DICTIONARY, Thirteenth Edition, John Wiley & Sons, Inc., (1997) (reproduced there with permission from IUPAC), unless reference is made to the Previous IUPAC form noted with Roman numerals (also appearing in the same), or unless otherwise noted.

As used herein, the term “slurry catalyst mixture” refers to a contact product that includes at least one catalyst compound and a carrier fluid (e.g., mineral oil), and optionally one or more of an activator, a co-activator, and a support. In a preferred embodiment, the slurry catalyst mixture includes a contact product that includes at least two catalyst compounds and the carrier fluid (e.g., mineral oil), and optionally one or more of an activator, a co-activator, and a support.

As used herein, the term “catalyst system” refers to a combination of at least one catalyst compound, an optional activator, an optional co-activator, and an optional support material. As such, in some embodiments the catalyst system can include only a single catalyst compound when the optional activator, the optional co-activator, and the optional support material are not present. In other embodiments, the catalyst system can include only two or more catalyst compounds when the optional activator, the optional co-activator, and the optional support material are not present. For the purposes of the present disclosure, when catalyst systems are described as including neutral stable forms of the components, it is well understood by one of ordinary skill in the art, that the ionic form of the component is the form that reacts with the monomers to produce polymers. Catalyst systems, catalysts, and activators of the present disclosure are intended to embrace ionic forms in addition to the neutral forms of the compounds/components.

A metallocene catalyst is an organometallic compound with at least one π-bound cyclopentadienyl moiety (or substituted cyclopentadienyl moiety) and more frequently two π-bound cyclopentadienyl moieties or substituted cyclopentadienyl moieties bonded to a transition metal. In the description herein, the metallocene catalyst may be described as a catalyst precursor, a pre-catalyst compound, metallocene catalyst compound or a transition metal compound, and these terms are used interchangeably. An “anionic ligand” is a negatively charged ligand which donates one or more pairs of electrons to a metal ion. For purposes of the present disclosure, in relation to metallocene catalyst compounds, the term “substituted” means that a hydrogen group has been replaced with a hydrocarbyl group, a heteroatom, or a heteroatom containing group. For example, methyl cyclopentadiene (Cp) is a Cp group substituted with a methyl group.

“Alkoxides” include an oxygen atom bonded to an alkyl group that is a C₁ to C₁₀ hydrocarbyl. The alkyl group may be straight chain, branched, or cyclic. The alkyl group may be saturated or unsaturated. In at least one embodiment, the alkyl group may comprise at least one aromatic group.

“Asymmetric” as used in connection with the instant indenyl compounds means that the substitutions at the 4 positions are different, or the substitutions at the 2 positions are different, or the substitutions at the 4 positions are different and the substitutions at the 2 positions are different.

The properties and performance of polyethylene compositions can be advanced by the combination of: (1) varying one or more reactor conditions such as reactor temperature, hydrogen concentration, comonomer concentration, and so on; and (2) selecting and feeding a dual catalyst system having a first catalyst and second catalyst; the dual catalyst system may advantageously be trimmed as needed with additional first and/or second catalyst. Such catalyst trim processes provide for ready adjustment of polyethylene properties by permitting on-the-fly adjustment of ratios of first and second catalyst in the dual catalyst system fed to the reactor.

In various embodiments in accordance with the present disclosure, the slurry catalyst mixture can include a first catalyst compound that can be a “high molecular weight component” and a second catalyst compound that can be a “low molecular weight component.” In other words, the first catalyst can provide primarily for a high molecular-weight portion of the polymer and the second catalyst can provide primarily for a low molecular weight portion of the polymer (e.g., the first catalyst tends to produce relatively higher-molecular-weight polymer chains; while the second catalyst tends to produce relatively lower-molecular-weight polymer chains). In at least one embodiment, a dual catalyst system can be present in a catalyst pot of a reactor system, and a molar ratio of the first catalyst compound to the second catalyst compound of the dual catalyst system can be from 99:1 to 1:99, such as from 90:10 to 10:90, such as from 85:15 to 50:50, such as from 75:25 to 50:50, such as from 60:40 to 40:60. Consistent with the above note regarding trim catalyst systems, the first catalyst compound and/or the second catalyst compound can be added to a polymerization process as a trim catalyst to adjust the molar ratio of the first catalyst compound to the second catalyst compound. In at least one embodiment, the first catalyst compound and the second catalyst compound are each a metallocene catalyst compound.

### Gas Phase Reactor

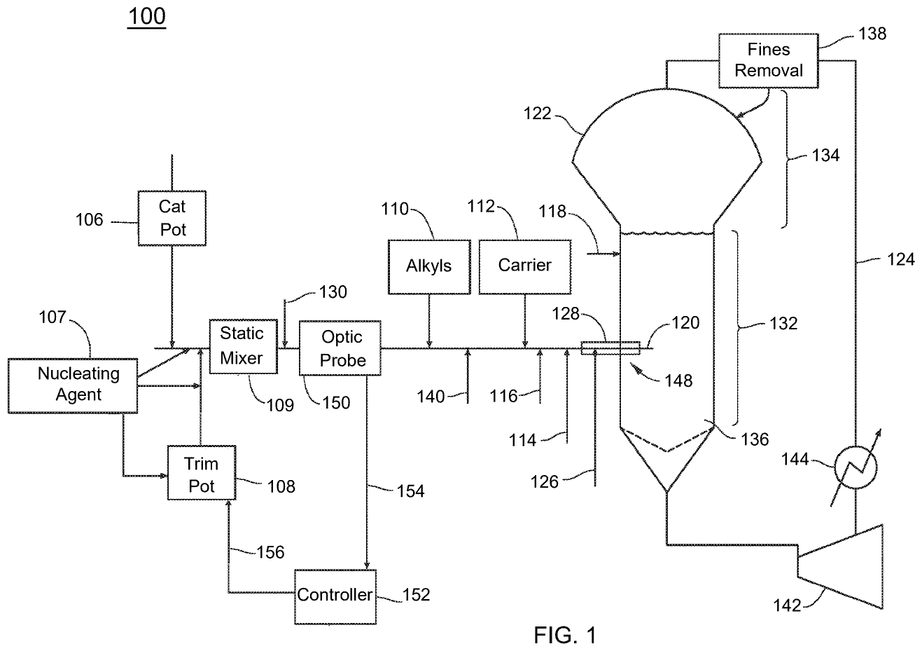

FIG. 1 is a schematic of a gas-phase reactor system 100, showing the addition of at least two catalysts, at least one of which is added as a trim catalyst. The catalyst slurry mixture from catalyst pot 106 and solution catalyst mixture from trim pot 108 can be mixed in-line. For example, the solution catalyst mixture and catalyst slurry mixture can be mixed by utilizing a mixer such as static mixer 109 or an agitating vessel. Alternatively, any suitable mixer may be used including mixing in a conduit, mixing using a mixing apparatus, or mixing in a continuously agitated tank, for example. Any mixer capable of contacting the solution catalyst mixture and catalyst slurry mixture can be used. Gas phase reactor system 100 includes optic probe 150 to analyze the mixture of the catalyst slurry mixture from catalyst pot 106 and solution catalyst mixture from trim pot 108.

Catalyst pot 106 contains a first catalyst slurry mixture. First catalyst slurry mixture can be prepared by any suitable method including by mixing particles of the first catalyst with mineral oil, for example. The catalyst pot 106 can be an agitated holding tank configured to keep the solids concentration homogenous. In at least one embodiment, the catalyst pot 106 can be maintained at an elevated temperature, such as from 30° C. to 80° C. Alternatively, from 30° C. to 40° C., from 40° C. to 50° C., from 50° C. to 60° C., from 60° C. to 80° C., or any ranges therebetween. Elevated temperature can be obtained by electrically heat tracing the catalyst pot 106 using, for example, a heating blanket. Maintaining the catalyst pot 106 at an elevated temperature can further reduce or eliminate solid residue formation on vessel walls which could otherwise slide off of the walls and cause plugging in downstream delivery lines. In at least one embodiment, catalyst pot 106 can have a volume from 0.5 m³ to 8.0 m³. Alternatively, from 0.5 m³ to 1.0 m³, 1.0 m³ to 2.0 m³, 2.0 m³ to 3.0 m³, 3.0 m³ to 4.0 m³, 4.0 m³ to 5.0 m³, 5.0 m³ to 6.0 m³, 6.0 m³ to 7.0 m³, 7.0 m³ to 8.0 m³, or any ranges therebetween.

In at least one embodiment, the catalyst pot 106 can be maintained at pressure of 1.0 bar to 4.0 bar. Alternatively, from 1.0 bar to 1.5 bar, 1.5 bar to 2.0 bar, 2.0 bar to 2.5 bar, 2.5 bar to 3.0 bar, 3.0 bar to 3.5 bar, 3.5 bar to 4.0 bar, or any ranges therebetween. In at least one embodiment, piping 130 and piping 140 of the gas-phase reactor system 100 can be maintained at an elevated temperature, such as from 30° C. to 80° C. Alternatively, from 30° C. to 40° C., from 40° C. to 50° C., from 50° C. to 60° C., from 60° C. to 80° C., or any ranges therebetween. Elevated temperature can be obtained by electrically heat tracing the piping 130 and or the piping 140 using, for example, a heating blanket. Maintaining the piping 130 and/or the piping 140 at an elevated temperature can provide the same or similar benefits as described for an elevated temperature of catalyst pot 106.

A solution catalyst mixture, prepared by mixing a solvent and at least one second catalyst and/or activator, can be placed in another vessel, such as a trim pot 108. Trim pot 108 can have a volume of 0.5 m³ to 1.0 m³, 1.0 m³ to 2.0 m³, 2.0 m³ to 3.0 m³, 3.0 m³ to 4.0 m³, 4.0 m³ to 5.0 m³, 5.0 m³ to 6.0 m³, 6.0 m³ to 7.0 m³, 7.0 m³ to 8.0 m³, or any ranges therebetween. The trim pot 108 can be maintained at an elevated temperature, such as from 30° C. to 80° C. Alternatively, from 30° C. to 40° C., from 40° C. to 50° C., from 50° C. to 60° C., from 60° C. to 80° C., or any ranges therebetween. The trim pot 108 can be heated by electrically heat tracing the trim pot 108, for example, via a heating blanket. Maintaining the trim pot 108 at an elevated temperature can provide reduced or eliminated foaming in piping 130 and or piping 140 when the catalyst slurry mixture from catalyst pot 106 is combined in-line (also referred to herein as “on-line”) with the solution catalyst mixture from trim pot 108.

The catalyst slurry mixture can then be combined in-line with the solution catalyst mixture to form a slurry/solution catalyst mixture or final catalyst composition. A nucleating agent 107, such as silica, alumina, fumed silica or any other particulate matter can be added to the slurry and/or the solution in-line or in catalyst pot 106 or trim pot 108. Similarly, additional activators or catalyst compounds can be added in-line. For example, a second catalyst slurry mixture that includes a different catalyst can be introduced from a second cat pot (which may include wax and mineral oil). The two catalyst slurry mixtures can be used as the catalyst system with or without the addition of a solution catalyst mixture from the trim pot 108. In embodiments, the solution catalyst mixture is analyzed by optic probe 150 as will be described in detail below. Optic probe 150 outputs a signal 154 to controller 152. Controller 152 may include a computer system, microcontrollers, programmable logic controller, or any other control system capable of monitoring and adjusting process variables within gas-phase reactor system 100. Controller 152 also may include other devices to carry out the control, including sensors, actuators, and a control algorithm.

Signal 154 can include data which represents a spectrum of the catalyst present in slurry catalyst mixture which controller 154 utilizes to determine the ratio of two active catalysts present in the catalyst. The spectral deconvolution of the spectrum of the catalyst to determine the ratio of the types of active catalyst sites will be discussed in detail below. The ratio can be compared to a target ratio or setpoint ratio to see if the slurry catalyst mixture is within specifications and if not, the controller 152 can output a signal 156 to adjust an amount of solution catalyst mixture from trim pot which is mixed in static mixer 109. The ratio of active sites in the slurry catalyst mixture can be adjusted in real time to control the polymerization process in fluidized bed reactor 122.

The catalyst slurry mixture and solution catalyst mixture can be mixed in-line. For example, the solution catalyst mixture and catalyst slurry mixture can be mixed by utilizing a mixer such as static mixer 109 or an agitating vessel. The mixing of the catalyst slurry mixture and the solution catalyst mixture should be sufficient enough to allow the catalyst compound in the solution catalyst mixture to disperse in the catalyst slurry mixture such that the catalyst component, originally in the solution, migrates to the supported activator originally present in the slurry. The combination can form a uniform dispersion of catalyst compounds on the supported activator forming the catalyst composition. The length of time that the slurry and the solution can be contacted can be in a range of 1 minute to 4 hours. Alternatively, from 1 minute to 10 minutes, 10 minutes to 30 minutes, 30 minutes to 1 hour, 1 hour to 1.5 hours, 1.5 hours to 2 hours, 2 hours to 2.5 hours, 2.5 hours to 3 hours, 3 hours to 3.5 hours, 3.5 hours to 4 hours, or any ranges therebetween.

In at least one embodiment, static mixer 109 of the gas-phase reactor system 100 can be maintained at an elevated temperature, such as from 30° C. to 80° C. Alternatively, from 30° C. to 40° C., from 40° C. to 50° C., from 50° C. to 60° C., from 60° C. to 80° C., or any ranges therebetween. The elevated temperature of the static mixer 109 can be obtained by electrically heat tracing static mixer 109 using, for example, a heating blanket. Maintaining static mixer 109 at an elevated temperature can provide reduced or eliminated foaming in static mixer 109 and can promote mixing of the catalyst slurry mixture and catalyst solution (as compared to lower temperatures) which reduces run times in the static mixer and for the overall polymerization process.

In another embodiment, an aluminum alkyl, an ethoxylated aluminum alkyl, an aluminoxane, an anti-static agent or a borate activator, such as a C₁ to C₁₅ alkyl aluminum (for example tri-isobutyl aluminum, trimethyl aluminum or the like), a C₁ to C₁₅ ethoxylated alkyl aluminum or methyl aluminoxane, ethyl aluminoxane, isobutylaluminoxane, modified aluminoxane or the like can be added to the mixture of the slurry/solution catalyst mixture in line. The alkyls, antistatic agents, borate activators and/or aluminoxanes can be added from an alkyl vessel 110 directly to the combination of the solution catalyst mixture and the catalyst slurry mixture, or can be added via an additional alkane (such as hexane, heptane, and or octane) carrier stream, for example, from a carrier vessel 112. The additional alkyls, antistatic agents, borate activators and/or aluminoxanes may be present at up to 500 ppm, at 1 to 300 ppm, at 10 ppm to 300 ppm, or at 10 to 100 ppm. A carrier gas 114 such as nitrogen, argon, ethane, propane, and the like, can be added in-line to the mixture of the slurry and the solution. In embodiments, the carrier gas can be added at the rate of 0.5 kg/hr to 45 kg/hr. Alternatively, from 0.5 kg/hr to 1.0 kg/hr, 1.0 kg/hr to 10 kg/hr, 10 kg/hr to 20 kg/hr, 20 kg/hr to 30 kg/hr, 30 kg/hr to 45 kg/hr, or any ranges therebetween.

In at least one embodiment, a liquid carrier stream can be introduced into the combination of the solution catalyst mixture and the catalyst slurry mixture. The mixture of the solution, the slurry and the liquid carrier stream can pass through a mixer or length of tube for mixing before being contacted with a gaseous carrier stream. Similarly, a comonomer 116, such as hexene, another alpha-olefin, or diolefin, may be added in-line to the mixture of the slurry and the solution.

In one embodiment, a gas stream 126, such as cycle gas, or recycle gas 124, monomer, nitrogen, or other materials can be introduced into an injection nozzle 148 that can include a support tube 128 that can at least partially surround an injection tube 120. The slurry/solution catalyst mixture can be passed through the injection tube 120 into fluidized bed reactor 122. In at least one embodiment, the injection tube may aerosolize the slurry/solution mixture. Any number of suitable tubing sizes and configurations may be used to aerosolize and/or inject the slurry/solution mixture.

Fluidized bed reactor 122 can include a reaction zone 132 and a velocity reduction zone 134. The reaction zone 132 can include a bed 136 that can include growing polymer particles, formed polymer particles and a minor amount of catalyst particles fluidized by the continuous flow of the gaseous monomer and diluent to remove the heat of polymerization through the reaction zone. Optionally, a portion of the recycle gas 124 can be cooled and compressed to form liquids that can increase the heat removal capacity of the circulating gas stream when readmitted to the reaction zone. A suitable rate of gas flow can be readily determined by experimentation. Make-up of gaseous monomer to the circulating gas stream can be at a rate equal to the rate at which particulate polymer product and monomer associated therewith is withdrawn from the reactor and the composition of the gas passing through the reactor can be adjusted to maintain an essentially steady state gaseous composition within the reaction zone. The gas leaving the reaction zone 132 can be passed to the velocity reduction zone 134 where entrained particles can be removed, for example, by slowing and falling back to the reaction zone 132. If desired, finer entrained particles and dust can be removed in a separation system 138. Such as a cyclone and/or fines filter. The recycle gas 124 can be passed through a heat exchanger 144 where at least a portion of the heat of polymerization can be removed. The gas can then be compressed in a compressor 142 and returned to the reaction zone 132. To promote formation of particles in fluidized bed reactor 122, a nucleating agent 118, such as fumed silica, can be added directly into fluidized bed reactor 122. Conventional trim polymerization processes include introducing a nucleating agent into the polymerization reactor. Furthermore, when a metallocene catalyst or other similar catalyst is used in the gas phase reactor, oxygen or fluorobenzene can be added to fluidized bed reactor 122 directly or to the gas stream 126 to control the polymerization rate.

FIG. 1 is not limiting, as additional solution catalyst mixtures and/or catalyst slurry mixtures can be used. For example, a catalyst slurry mixture can be combined with two or more solution catalyst mixtures having the same or different catalyst compounds and or activators. Likewise, the solution catalyst mixture can be combined with two or more catalyst slurry mixtures each having the same or different supports, and the same or different catalyst compounds and or activators. Similarly, two or more catalyst slurry mixtures can be combined with two or more solution catalyst mixtures, for example in-line, where the catalyst slurry mixtures each include the same or different supports and can include the same or different catalyst compounds and or activators and the solution catalyst mixtures can include the same or different catalyst compounds and or activators. For example, the catalyst slurry mixture can contain a supported activator and two different catalyst compounds, and two solution catalyst mixtures, each containing one of the catalysts in the slurry, and each can be independently combined, in-line, with the slurry.

The reactor temperature of the fluid bed process can be in a range of 30° C. to 200° C. Alternatively, from 30° C. to 40° C., 40° C. to 50° C., 50° C. to 80° C., 80° C. to 100° C., 100° C. to 150° C., 150° C. to 200° C., or any ranges therebetween. In general, the reactor temperature can be operated at a suitable temperature taking into account the sintering temperature of the polymer product within the reactor. Thus, the upper temperature limit in various embodiments can be the melting temperature of the polyethylene copolymer produced in the reactor. However, higher temperatures can result in narrower molecular weight distributions that can be improved by the addition of a catalyst, or other co-catalysts.

Hydrogen gas can be used in the polymerization process to help control or otherwise adjust the final properties of the polyolefin. Using certain catalyst systems, increasing concentrations (partial pressures) of hydrogen can increase a flow index such as the melt index of the polyethylene polymer. The melt index can thus be influenced by the hydrogen concentration. The amount of hydrogen in the polymerization can be expressed as a mole ratio relative to the total polymerizable monomer, for example, ethylene, or a blend of ethylene and hexene or propylene. The amount of hydrogen used in the polymerization process can be an amount necessary to achieve the desired melt index of the final polyolefin polymer. For example, the mole ratio of hydrogen to total monomer (H₂:monomer) can be 0.0001 or greater, 0.0005 or greater, or 0.001 or greater. Further, the mole ratio of hydrogen to total monomer (H₂:monomer) can be 10 or less, 5 or less, 3 or less, or 0.10 or less. A range for the mole ratio of hydrogen to monomer can include any combination of any upper mole ratio limit with any lower mole ratio limit described herein. The amount of hydrogen in the reactor at any time can range to up to 5,000 ppm, up to 4,000 ppm in another embodiment, up to 3,000 ppm, or from 50 ppm to 5,000 ppm, or from 50 ppm to 2,000 ppm in another embodiment. The amount of hydrogen in the reactor can be from 1 ppm, 50 ppm, or 100 ppm to 400 ppm, 800 ppm, 1,000 ppm, 1,500 ppm, or 2,000 ppm, based on weight. Further, the ratio of hydrogen to total monomer (H₂:monomer) can be 0.00001:1 to 2:1, 0.005:1 to 1.5:1, or 0.0001:1 to 1:1. The one or more reactor pressures in a gas phase process (either single stage or two or more stages) can vary from 690 kPa, 1,379 kPa, or 1,724 kPa to 2,414 kPa, 2,759 kPa, or 3,448 kPa.

The gas phase reactor can be capable of producing from 10 kg per hour (kg/hr), greater than 455 kg/hr, greater than 4,540 kg/hr, greater than 11,300 kg/hr, greater than 15,900 kg/hr, greater than 22,700 kg/hr, or greater than 29,000 kg/hr to 45,500 kg/hr of polymer.

In embodiments, the polymer product can have a melt index ratio (MIR) ranging from 10 to less than 300, or, in many embodiments, from 20 to 66, such as 25 to 55. The melt index (MI, 12) can be measured in accordance with ASTM D-1238-20.

The polymer product can have a density ranging from 0.89 g/cm³, 0.90 g/cm³, 0.91 g/cm³, or 0.92 g/cm³ to 0.93 g/cm³, 0.95 g/cm³, 0.96 g/cm³, or 0.97 g/cm³. Density can be determined in accordance with ASTM D-792-20. The polymer can have a bulk density, measured in accordance with ASTM D-1895-17 method B, of from 0.25 g/cm³ to 0.5 g/cm³. For example, the bulk density of the polymer can be from 0.30 g/cm³, 0.32 g/cm³, or 0.33 g/cm³ to 0.40 g/cm³, 0.44 g/cm³, or 0.48 g/cm³.

Polymerization process according to various embodiments can include contacting one or more olefin monomers with a catalyst slurry mixture that can include mineral oil and catalyst particles. The one or more olefin monomers can be ethylene and/or propylene and the polymerization process can include heating the one or more olefin monomers and the catalyst system to 70° C. or more to form ethylene polymers or propylene polymers.

Monomers useful herein include substituted or unsubstituted C₂ to C₄₀ alpha olefins, such as C₂ to C₂₀ alpha olefins, such as C₂ to C₁₂ alpha olefins, such as ethylene, propylene, butene, pentene, hexene, heptene, octene, nonene, decene, undecene, dodecene and isomers thereof. In at least one embodiment, the monomer can include ethylene and one or more optional comonomers selected from propylene or C₄ to C₄₀ olefins, such as C₄ to C₂₀ olefins, such as C₆ to C₁₂ olefins. The C₄ to Cao olefin monomers may be linear, branched, or cyclic. The C₄ to C₄₀ cyclic olefins may be strained or unstrained, monocyclic or polycyclic, and may optionally include heteroatoms and/or one or more functional groups.

In some embodiments, the C₂ to C₄₀ alpha olefin monomers and optional comonomers include ethylene, propylene, butene, pentene, hexene, heptene, octene, nonene, decene, undecene, dodecene, norbornene, norbornadiene, dicyclopentadiene, cyclopentene, cycloheptene, cyclooctene, cyclooctadiene, cyclododecene, 7-oxanorbornene, 7-oxanorbornadiene, substituted derivatives thereof, and isomers thereof, such as hexene, heptene, octene, nonene, decene, dodecene, cyclooctene, 1,5-cyclooctadiene, 1-hydroxy-4-cyclooctene, 1-acetoxy-4-cyclooctene, 5-methylcyclopentene, cyclopentene, dicyclopentadiene, norbornene, norbornadiene, and their respective homologs and derivatives, such as norbornene, norbornadiene, and dicyclopentadiene.

In at least one embodiment, one or more dienes can be present in the polymer product at up to 10 wt. %, such as at 0.00001 to 1.0 wt. %, such as 0.002 to 0.5 wt. %, such as 0.003 to 0.2 wt. %, based upon the total weight of the composition. In at least one embodiment 500 ppm or less of diene is added to the polymerization, such as 400 ppm or less, such as 300 ppm or less. In other embodiments at least 50 ppm of diene is added to the polymerization, or 100 ppm or more, or 150 ppm or more.

Diene monomers include any hydrocarbon structure, such as C₄ to C₃₀, having at least two unsaturated bonds, where at least two of the unsaturated bonds are readily incorporated into a polymer by either a stereospecific or a non-stereospecific catalyst(s). The diene monomers can be selected from alpha, omega-diene monomers (i.e. di-vinyl monomers). The diolefin monomers are linear di-vinyl monomers, such as those containing from 4 to 30 carbon atoms. Examples of dienes can include, but are not limited to, butadiene, pentadiene, hexadiene, heptadiene, octadiene, nonadiene, decadiene, undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene, 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, and low molecular weight polybutadienes (Mw less than 1000 g/mol). Cyclic dienes include cyclopentadiene, vinylnorbornene, norbornadiene, ethylidene norbornene, divinylbenzene, dicyclopentadiene or higher ring containing diolefins with or without substituents at various ring positions.

In at least one embodiment, the catalyst disclosed herein can be capable of producing ethylene polymers having an Mw from 40,000 g/mol, 70,000 g/mol, 90,000 g/mol, or 100,000 g/mol to 200,000 g/mol, 300,000 g/mol, 600,000 g/mol, 1,000,000 g/mol, or 1,500,000 g/mol. In at least one embodiment, the catalyst disclosed herein can be capable of producing ethylene polymers having a melt index (MI) of 0.6 or greater g/10 min, such as 0.7 or greater g/10 min, such as 0.8 or greater g/10 min, such as 0.9 or greater g/10 min, such as 1.0 or greater g/10 min, such as 1.1 or greater g/10 min, such as 1.2 or greater g/10 min.

“Catalyst productivity” is a measure of how many grams of polymer (P) are produced using a polymerization catalyst comprising W g of catalyst (cat), over a period of time of T hours; and can be expressed by the following formula: P/(T×W) and expressed in units of gPgcat⁻¹hr⁻¹. In at least one embodiment, the productivity of the catalysts disclosed herein can be at least 50 g(polymer)/g(cat)/hour, such as 500 or more g(polymer)/g(cat)/hour, such as 800 or more g(polymer)/g(cat)/hour, such as 5,000 or more g(polymer)/g(cat)/hour, such as 6,000 or more g(polymer)/g(cat)/hour.

### Process for Making Slurry Catalyst Mixture

A container or vessel can be used to produce or otherwise make the slurry catalyst mixture. One or more mineral oils can be introduced into the vessel. The mineral oil can be heated within the vessel to a temperature of 30° C. to 100° C. Alternatively, from 30° C. to 40° C., from 40° C. to 50° C., from 50° C. to 60° C., from 60° C. to 80° C., from 80° C. to 100° C. or any ranges therebetween to produce a heated mineral oil. A moisture concentration of the heated mineral oil can be reduced to produce a dried mineral oil. For instance, moisture concentration of the heated mineral oil can be reduced by at least one of: (i) passing a first inert gas through the heated mineral oil, (ii) passing a second inert gas through a headspace of the vessel, (iii) subjecting the heated mineral oil to a vacuum, and (iv) adding an aluminum-containing compound to the heated mineral oil. In various embodiments, two or more, three or more, or four or more of the above may be employed in combination; for instance, a combination of (i) and (ii) may be employed per some embodiments; and/or a combination of (iii) and (iv) in particular embodiments.

Regarding (i) and (ii), the first and/or second inert gases can independently be or include, but are not limited to, nitrogen, carbon dioxide, argon, or any mixture thereof. Amounts of first and/or second inert gas (passed through the mineral oil or into the head space of the vessel) can be gauged in terms of volumetric turnovers (where each turnover equals the volume of the vessel), and can range from a low of 5, 10, 15, or 20 volumetric turnovers to 30, 40, 45, 50, 55, or 60 volumetric turnovers (with ranges from any low to any high contemplated). Vessel volume is not limited but may for instance range from a low of any one of 0.75, 1.15, 1.5, 1.9, or 2.3 m³ to a high of 3, 3.8, 5.7, or 7.6 m³. Regarding (iii), the heated mineral oil can be subjected to a vacuum, i.e., a pressure of <101 kPa-absolute, <75 kPa-absolute, <60 kPa-absolute, or <55 kPa-absolute. Vacuum pressures in various embodiments may range from a low of any one of 0.67, 1, 10, 15, or 20 kPa-absolute to a high of any one of 30, 40, 55, 60, 65, or 80 kPa-absolute, with ranges from any foregoing low end to any foregoing high end contemplated herein. The heated mineral oil can be subjected to the vacuum for at time period of 1 hr, 2, hr, 3 hr, 4 hr, or 5 hr to 6 hr, 8 hr, 10 hr, 12 hr, 24 hr, or longer. Regarding (iv), the aluminum-containing compound can be or can include, but is not limited to, a compound represented by the formula AlR₍₃₋ₐ₎Xₐ, where R is a branched or straight chain alkyl, cycloalkyl, heterocycloalkyl, aryl, or a hydride radical having from 1 to 30 carbon atoms, X is a halogen, and a is 0, 1, or 2. For instance, the aluminum-containing compound can be or can include tri-hexyl-aluminum, triethylaluminum, trimethylaluminum, triisobutylaluminum, di-isobutylaluminum bromide, di-isobutylaluminum hydride, methyl aluminoxane, modified methyl aluminoxane, ethylaluminoxane, isobutylaluminoxane, or any mixture thereof. The modified methyl aluminoxane can be produced by the hydrolysis of trimethylaluminum and a higher trialkylaluminum, such as triisobutylaluminum. Modified methyl aluminoxanes are generally more soluble in aliphatic solvents and more stable during storage. There are a variety of well-known processes for preparing aluminoxanes and modified aluminoxanes.

In some embodiments, the moisture concentration of the dried mineral oil can be ≤100 ppmw, ≤85 ppmw, ≤70 ppmw, ≤60 ppmw, ≤55 ppmw, ≤50 ppmw, ≤45 ppmw, ≤40 ppmw, ≤ 35 ppmw, ≤30 ppmw, ≤25 ppmw, or ≤20 ppmw, as measured according to ASTM D1533-12. In some embodiments, the dried mineral oil can have a density of 0.85 g/cm³, 0.86 g/cm³, or 0.87 g/cm³ to 0.88 g/cm³, 0.89 g/cm³, or 0.9 g/cm³ at 25° C. according to ASTM D4052-18a. In some embodiments, the dried mineral oil can have a kinematic viscosity at 40° C. of 50 cSt, 75 cSt, or 100 cSt to 150 cSt, 200 cSt, 250 cSt, or 300 cSt according to ASTM D341-20e1. In some embodiments, the dried mineral oil can have an average molecular weight of 250 g/mol, 300 g/mol, 350 g/mol, 400 g/mol, 450 g/mol, or 500 g/mol to 550 g/mol, 600 g/mol, 650 g/mol, 700 g/mol, or 750 g/mol according to ASTM D2502-14(2019)e1.

Once the dried mineral oil has been produced, catalyst particles can be introduced into the dried mineral oil to produce a mixture. The mixture can be mixed, blended, stirred, or otherwise agitated for at least 2 hours to remove at least a portion of any gas that can be present within the pores of the catalyst particles, to produce the slurry catalyst mixture. In some embodiments, the mixture can be agitated for 2 hours, 2.5 hours, 3 hours, 3.5 hours, 4 hours, 4.5 hours, 5 hours, or more to produce the slurry catalyst mixture. In some embodiments, the temperature of the mixture can be maintained at a temperature of 50° C., 55° C., 60° C., or 65° C. to 75° C., 80° C., 85° C., or 90° C. during agitation of the mixture. In other embodiments, the temperature of the mixture can be allowed to cool down. For example, the mixture can be allowed to cool down to a temperature of 45° C., 40° C., 35° C., or 30° C. during agitation of the mixture.

In some embodiments, the vessel can include one or more mixing apparatus that can be configured to mix, blend, stir, or otherwise agitate the mixture within the vessel. In some embodiments, the mixing apparatus can be a rotatable mixing apparatus. Suitable rotatable mixing apparatus can include one or more blades or impellers configured to agitate one or more components of the slurry catalyst mixture within the vessel when rotated. The rotatable mixing apparatus can be rotated at 40 rotations per minute (rpm), 50 rpm, 75 rpm, or 100 rpm to 150 rpm, 175 rpm, 200 rpm, 225 rpm, or 250 rpm. In other embodiments, the mixture can be agitated via ultrasonic waves. In still other embodiments, the mixture can be agitated by moving the vessel, e.g., rolling the vessel or rotating the vessel back and forth an axis thereof.

The mineral oil may also be agitated during introduction into the vessel; during heating of the mineral oil; during reduction of the moisture concentration in the mineral oil; and/or during introduction of the catalyst particles to the mineral oil.

The mineral oil in the slurry catalyst mixture can also be referred to as a diluent. In some embodiments, in addition to the mineral oil, the slurry catalyst mixture can also include one or more additional diluents. Additional diluents can be or can include, but are not limited to, toluene, ethylbenzene, xylene, pentane, hexane, heptane, octane, other hydrocarbons, or any combination thereof.

In some embodiments, the slurry catalyst mixture can have a solids content of 1 wt. % to 40 wt. %. Alternatively, from 1 wt. % to 5 wt. %, from 5 wt. % to 10 wt. %, from 10 wt. % to 15 wt. %, from 15 wt. % to 20 wt. %, from 20 wt. % to 25 wt. %, from 25 wt. % to 30 wt. %, from 35 wt. % to 40 wt. %, or any ranges therebetween.

Although wax has heretofore been considered necessary for many slurry catalyst mixtures, e.g., for stability (especially for storage and transport), it is noted that slurry catalyst mixtures of various embodiments herein may advantageously omit the wax. Thus, according to such embodiments, the slurry catalyst mixture can be free of any wax having a melting point, at atmospheric pressure, of ≥25° C., based on a total weight of the slurry catalyst mixture. More generally, the slurry catalyst mixture can include ≤3 wt. %, ≤2.5 wt. %, ≤2 wt. %, ≤1.5 wt. %, ≤1 wt. %, ≤0.9 wt. %, ≤0.8 wt. %, ≤0.7 wt. %, ≤0.6 wt. %, ≤0.5 wt. %, ≤0.4 wt. %, ≤0.3 wt. %, ≤0.2 wt. %, or ≤0.1 wt. % of any wax having a melting point, at atmospheric pressure, of ≥25° C., based on a total weight of the slurry catalyst mixture. As used herein, the term “wax” includes a petrolatum also known as petroleum jelly or petroleum wax. Petroleum waxes include paraffin waxes and microcrystalline waxes, which include slack wax and scale wax. In at least one embodiment, the wax, if present, can have a density (at 100° C.) of 0.7 g/cm³, 0.73 g/cm³, or 0.75 g/cm³ to 0.87 g/cm³, 0.9 g/cm³, or 0.95 g/cm³. The wax, if present, can have a kinematic viscosity at 100° C. of 5 cSt, 10 cSt, or 15 cSt to 25 cSt, 30 cSt, or 35 cSt. The wax, if present, can have a melting point, at atmospheric pressure, of 25° C., 35° C., or 50° C. to 80° C., 90° C., or 100° C. The wax, if present can have a boiling point of 200° C. or greater, 225° C. or greater, or 250° C. or greater.

The term “wax” also refers to or otherwise includes any wax not considered a petroleum wax, which include animal waxes, vegetable waxes, mineral fossil or earth waxes, ethylenic polymers and polyol ether-esters, chlorinated naphthalenes, and hydrocarbon type waxes. Animal waxes can include beeswax, lanolin, shellac wax, and Chinese insect wax. Vegetable waxes can include carnauba, candelilla, bayberry, and sugarcane. Fossil or earth waxes can include ozocerite, ceresin, and montan. Ethylenic polymers and polyol ether-esters include polyethylene glycols and methoxypolyethylene glycols. The hydrocarbon type waxes include waxes produced via Fischer-Tropsch synthesis.

Once the slurry catalyst mixture has been produced, the slurry catalyst mixture can be transferred from the vessel into a catalyst pot or cat pot configured to introduce the slurry catalyst mixture into a gas phase polymerization reactor, such as the gas phase polymerization reactor described in FIG. 1. As such, in various embodiments, the vessel can be located on-site at a manufacturing facility that includes a gas phase polymerization reactor. By making the slurry catalyst mixture on-site at the manufacturing facility, the use of slurry catalyst cylinders to transport the slurry catalyst mixture can be avoided because the slurry catalyst mixture, upon preparation, can be introduced into the catalyst pot or “cat pot” from which the slurry catalyst mixture can be introduced into the gas phase polymerization reactor. In some embodiments, by making the slurry catalyst mixture on-site at the manufacturing facility, the slurry catalyst mixture can be introduced into the gas phase polymerization reactor within a time period of ≤180 minutes, ≤150 minutes, ≤125 minutes, ≤100 minutes, ≤80 minutes, ≤60 minutes, ≤50 minutes, or ≤40 minutes upon initiation of agitation of the mixture. In other embodiments, by making the slurry catalyst mixture on-site at the manufacturing facility, the slurry catalyst mixture can be introduced into the gas phase polymerization reactor within a time period of ≤180 minutes, ≤150 minutes, ≤125 minutes, ≤100 minutes, ≤80 minutes, ≤60 minutes, ≤50 minutes, or ≤40 minutes upon ceasing or stopping agitation of the mixture.

Although, as noted above, wax advantageously may be omitted where storage and/or transport stability are not required for certain catalyst mixtures, it was surprisingly discovered that wax and/or additional diluent in certain catalyst mixtures can aid in the polymerization process in certain cases, e.g., depending on identity(ies) of catalyst compound(s) in the slurry catalyst mixture. Thus, surprisingly, even when one would otherwise think that omitting wax or other diluents is desired (e.g., because there is no need for added storage/transportation stability), it is found that certain catalyst slurries should include wax or other diluents. Thus, processes according to various embodiments may include identifying slurry catalyst mixture(s) for which wax and/or additional diluent is desired and including wax in such slurry catalyst mixture(s) (preferably also while not including wax and/or additional diluent in slurry catalyst mixtures where no processing advantage is obtained by the presence of the wax and/or diluent).

Accordingly, polymerization processes per some embodiments can include, at a first time, introducing a carrier gas, one or more olefins, and a first slurry catalyst mixture into a polymerization reactor. The first slurry catalyst mixture can include a contact product of one or more catalysts selected from a first group of catalysts, a first support, a first activator, a first mineral oil, and a wax having a melting point, at atmospheric pressure, of ≥25° C. The first slurry catalyst mixture can include >1 wt. % of the wax, based on a total weight of the first slurry catalyst mixture. The one or more olefins can be polymerized in the presence of the first catalyst within the polymerization reactor to produce a first polymer product.

Then, at a second time after the first time, a second slurry catalyst mixture can be introduced into the polymerization reactor. This can occur, e.g., as part of a grade transition or the like in a polymer production campaign (e.g., first slurry catalyst mixture may be stopped before, during, or soon after introduction of the second slurry catalyst mixture). The second slurry catalyst mixture can include a contact product of one or more catalysts selected from a second group of catalysts, a second support, a second activator, and a second mineral oil. The one or more catalysts selected from the second group of catalysts are preferably different from the one or more catalysts selected from the first group of catalysts; however, the first and second supports, activators, and/or mineral oils can be the same or different. The second slurry catalyst mixture, contrary to the first slurry catalyst mixture, can be free of or include ≤1 wt. % of any wax having a melting point, at atmospheric pressure, of ≥25° C., based on a total weight of the slurry catalyst mixture. The second slurry catalyst mixture can in particular be produced according to process described above, entailing removing of moisture from the slurry catalyst mixture. The polymerization process can also include polymerizing the one or more olefins in the presence of the second catalyst within the polymerization reactor to produce a second polymer product. In some embodiments, the carrier gas can be or can include, but is not limited to, nitrogen, argon, ethane, propane, or any mixture thereof. In some embodiments, the one or more olefins can be or can include one more substituted or unsubstituted C₂ to C₄₀ alpha olefins, as further described below.

In particular, it is believed that catalysts in the first group of catalysts and those of the second group of catalysts will preferably have different bulk densities; this aids in identifying which slurry catalyst mixtures may benefit from wax and/or additional diluent, and which will not. For instance, the one or more catalysts in the first group of catalysts can have a bulk density of ≥0.43 g/cm³, ≥0.44 g/cm³, or ≥0.45 g/cm³. On the other hand, the one or more catalysts in the second group of catalysts can have a bulk density of <0.45 g/cm³, <0.44 g/cm³, <0.43 g/cm³, <0.42 g/cm³, <0.41 g/cm³, or <0.40 g/cm³. Put in other words, in various embodiments, the bulk density of the one or more catalyst in the first group of catalysts is greater than the bulk density of the one or more catalysts in the second group of catalysts.

### Catalyst Particles

The catalyst or catalyst compounds can be or can include, but are not limited to, one or more metallocene catalyst compounds. In some embodiments, the catalyst can include at least a first metallocene catalyst compound and a second metallocene catalyst compound, where the first and second metallocene catalyst compounds have different chemical structures from one another. Metallocene catalyst compounds can include catalyst compounds having one or more Cp ligands (cyclopentadienyl and ligands isolobal to cyclopentadienyl) bound to at least one Group 3 to Group 12 metal atom, and one or more leaving group(s) bound to the at least one metal atom. In further embodiments, the catalyst further includes a third and/or a fourth metallocene catalyst compound where the third and fourth metallocene catalyst compounds have different chemical structures from one another and different chemical structures than the first and second metallocene catalyst compounds.

Also suitable are catalyst systems employing a mix of two metallocene catalysts, and in particular, a mix of (1) a bis-cyclopentadienyl hafnocene (preferably a bridged bis-cyclopentadienyl hafnocene) and (2) a zirconocene, such as an indenyl-cyclopentadienyl zirconocene (preferably an unbridged indenyl-cyclopentadienyl zirconocene).

In embodiments, the metallocene catalyst compounds include a hafnocene. Suitable hafnocenes can include bridged or unbridged hafnocenes, preferably bridged hafnocenes, such as bis(n-propylcyclopentadienyl)hafnium dichloride, bis(n-propylcyclopentadienyl)hafnium dimethyl, (n-propylcyclopentadienyl, pentamethylcyclopentadienyl)hafnium dichloride, (n-propylcyclopentadienyl, pentamethylcyclopentadienyl)hafnium dimethyl, (n-propylcyclopentadienyl, tetramethylcyclopentadienyl)hafnium dichloride, (n-propylcyclopentadienyl, tetramethylcyclopentadienyl)hafnium dimethyl, bis(cyclopentadienyl)hafnium dimethyl, bis(n-butylcyclopentadienyl)hafnium dichloride, bis(n-butylcyclopentadienyl)hafnium dimethyl, and bis(1-methyl-3-n-butylcyclopentadienyl)hafnium dimethyl, and combinations thereof.

Other suitable hafnocene compounds include, but are not limited to, rac/meso Me₂Si(Me₃SiCH₂Cp)₂HfMe₂; racMe₂Si(Me₃SiCH₂Cp)₂HfMe₂; rac/meso Ph₂Si(Me₃SiCH₂Cp)₂HfMe₂; rac/meso (CH₂)₃Si(Me₃SiCH₂Cp)₂HfMe₂; rac/meso rac/meso (C₆F₅)₂Si(Me₃SiCH₂Cp)₂HfMe₂; rac/meso (CH₂)₃Si(Me₃SiCH₂Cp)₂ZrMe₂; rac/meso Me₂Ge(Me₃SiCH₂Cp)₂HfMe₂; rac/meso Me₂Si(Me₂PhSiCH₂Cp)₂HfMe₂; rac/meso Ph₂Si(Me₂PhSiCH₂Cp)₂HfMe₂; Me₂Si(Me₄Cp)(Me₂PhSiCH₂Cp)HfMe₂, and combinations thereof.

As noted above, suitable catalyst compounds also or instead may include a zirconocene, such as an unbridged zirconocene including, but not limited to, bis(indenyl)zirconium dichloride, bis(indenyl)zirconium dimethyl, bis(tetrahydro-1-indenyl)zirconium dichloride, bis(tetrahydro-1-indenyl)zirconium dimethyl, rac/meso-bis(1-ethylindenyl)zirconium dichloride, rac/meso-bis(1-ethylindenyl)zirconium dimethyl, rac/meso-bis(1-methylindenyl)zirconium dichloride, rac/meso-bis(1-methylindenyl)zirconium dimethyl, rac/meso-bis(1-propylindenyl)zirconium dichloride, rac/meso-bis(1-propylindenyl)zirconium dimethyl, rac/meso-bis(1-butylindenyl)zirconium dichloride, rac/meso-bis(1-butylindenyl)zirconium dimethyl, meso-bis(1ethylindenyl)zirconium dichloride, meso-bis(1-ethylindenyl)zirconium dimethyl, (1-methylindenyl)(pentamethyl cyclopentadienyl)zirconium dichloride, (1-methylindenyl)(pentamethyl cyclopentadienyl) zirconium dimethyl, and combinations thereof.

### Slurry Catalyst Mixture Including Activators and Supports

As noted above, the slurry catalyst mixture can include one or more activators and/or supports in addition to one or more catalysts. The term “activator” refers to any compound or combination of compounds, supported or unsupported, which can activate a single site catalyst compound or component, such as by creating a cationic species of the catalyst component. For example, this can include the abstraction of at least one leaving group (the ‘X’ group in the single site catalyst compounds described herein) from the metal center of the single site catalyst compound/component. The activator may also be referred to as a “co-catalyst’. For example, the slurry catalyst mixture can include two or more activators (such as aluminoxane and a modified aluminoxane) and a catalyst compound, or the slurry catalyst mixture can include a supported activator and more than one catalyst compound. In particular embodiments, the slurry catalyst mixture can include at least one support, at least one activator, and at least two catalyst compounds. For example, the slurry can include at least one support, at least one activator, and two different catalyst compounds that can be added separately or in combination to produce the slurry catalyst mixture. In some embodiments, a mixture of a support, e.g., silica, and an activator, e.g., aluminoxane, can be contacted with a catalyst compound, allowed to react, and thereafter the mixture can be contacted with another catalyst compound, for example, in a trim system.

The molar ratio of metal in the activator to metal in the catalyst compound in the slurry catalyst mixture can be 1000:1 to 0.5:1, 300:1 to 1:1, 100:1 to 1:1, or 150:1 to 1:1. The slurry catalyst mixture can include a support material which can be any inert particulate carrier material known in the art, including, but not limited to, silica, fumed silica, alumina, clay, talc or other support materials such as disclosed above. In one embodiment, the slurry can include silica and an activator, such as methyl aluminoxane (“MAO”), modified methyl aluminoxane (“MMAO), as discussed further below. In embodiments, activators include aluminoxane compounds, modified aluminoxane compounds, and ionizing anion precursor compounds that abstract a reactive, σ-bound, metal ligand making the metal compound cationic and providing a charge-balancing non-coordinating or weakly coordinating anion.

As noted above, one or more organo-aluminum compounds such as one or more alkylaluminum compounds can be used in conjunction with the aluminoxanes. For example, alkylaluminum species that can be used include diethylaluminum ethoxide, diethylaluminum chloride, and/or diisobutylaluminum hydride. Examples of trialkylaluminum compounds include, but are not limited to, trimethylaluminum, triethylaluminum (“TEAL), triisobutylaluminum “TiBAl), tri-n-hexylaluminum, tri-n-octylaluminum, tripropylaluminum, tributylaluminum, and the like.

Suitable supports include, but are not limited to, active and inactive materials, synthetic or naturally occurring zeolites, as well as inorganic materials such as clays and/or oxides such as silica, alumina, zirconia, titania, silica-alumina, cerium oxide, magnesium oxide, or combinations thereof. In particular, the support may be silica-alumina, alumina and/or a zeolite, particularly alumina. Silica-alumina may be either naturally occurring or in the form of gelatinous precipitates or gels including mixtures of silica and metal oxides.

In some embodiments, at least a portion of the slurry catalyst mixture can be contacted with a solution catalyst mixture to produce or otherwise form a slurry/solution catalyst mixture.

### Solution Catalyst Mixture—Trim Solution

The solution catalyst mixture can include a solvent and only catalyst compound(s), such as a metallocene, or can also include an activator. In some embodiments, the solution catalyst mixture can be or can include, but is not limited to, a contact product of a solvent/diluent and the first catalyst or the second catalyst. In some embodiments, the slurry/solution catalyst mixture can be introduced into the gas phase polymerization reactor. In at least one embodiment, the catalyst compound(s) in the solution catalyst mixture can be unsupported.

The solution catalyst mixture, if used, can be prepared by dissolving the catalyst compound and optional activators in a liquid solvent. In some embodiments, the liquid solvent can be an alkane, such as a C₅ to C₃₀ alkane, or a C₅ to C₁₀ alkane. Cyclic alkanes such as cyclohexane and aromatic compounds such as toluene can also be used. Mineral oil can be used as a solvent alternatively or in addition to other alkanes such as one or more C₅ to C₃₀ alkanes. The mineral oil in the solution catalyst mixture, if used, can have the same properties as the mineral oil that can be used to make the slurry catalyst mixture described above. The solvent employed should be liquid under the conditions of polymerization and relatively inert. In one embodiment, the solvent utilized in the solution catalyst mixture can be different from the diluent used in the slurry catalyst mixture. In another embodiment, the solvent utilized in the solution catalyst mixture can be the same as the diluent, i.e., the mineral oil(s) and any additional diluents used in the slurry catalyst mixture.

If the solution catalyst mixture includes both the catalyst and an activator, the ratio of metal in the activator to metal in the catalyst in the solution catalyst mixture can be 1000:1 to 0.5:1, 300:1 to 1:1, or 150:1 to 1:1. In various embodiments, the activator and catalyst can be present in the solution catalyst mixture at up to 90 wt. %, at up to 50 wt. %, at up to 20 wt. %, such as at up to 10 wt. %, at up to 5 wt. %, at less than 1 wt. %, or between 100 ppm and 1 wt. %, based on the weight of the solvent, the activator, and the catalyst. The one or more activators in a solution catalyst mixture, if used, can be the same or different as the one or more activators used in a slurry catalyst mixture.

The solution catalyst mixture can include any one of the catalyst compound(s) of the present disclosure. As the catalyst is dissolved in the solution, a higher solubility can be desirable. Accordingly, the catalyst in the solution catalyst mixture can often include a metallocene, which may have higher solubility than other catalysts. In the polymerization process any of the above described solution catalyst mixtures can be combined with any of the slurry catalyst mixtures described above. In addition, more than one solution catalyst mixture can be utilized.

### Continuity Additive—Static Control Agent

In gas-phase polyethylene production processes, it can be desirable to use one or more static control agents to help facilitate the regulation of static levels within the reactor. The continuity additive is a chemical composition that, when introduced into the fluidized bed within the reactor, can influence or drive static charge (negative, positive, or to zero) in the fluidized bed. The continuity additive used can depend, at least in part, on the nature of the static charge, and the choice of static control agent can vary depending, at least in part, on the polymer being produced and/or the single site catalyst compounds being used. In some embodiments, the continuity additive or static control agent can be introduced into the reactor in an amount of 0.05 ppm to 200 ppm. Alternatively, from 0.05 ppm to 2 ppm, 5 ppm, 10 ppm, or 20 ppm to 50 ppm, 75 ppm, 100 ppm, 150 ppm, 200 ppm.

In some embodiments, the continuity additive can be or can include aluminum stearate. The continuity additive can be selected for its ability to receive the static charge in the fluidized bed without adversely affecting productivity. Other suitable continuity additives can be or can include, but are not limited to, aluminum distearate, ethoxylated amines, and combinations thereof. In embodiments the continuity additive includes a mixture of a polysulfone copolymer, a polymeric polyamine, and oil soluble sulfonic acid. Any of the continuity additives can be used either alone or in combination.

In some embodiments, the continuity additive can include fatty acid amines, amide-hydrocarbon or ethyoxylated-amide compounds, carboxylate compounds such as aryl-carboxylates and long chain hydrocarbon carboxylates, and fatty acid-metal complexes; alcohols, ethers, sulfate compounds, metal oxides and other compounds known in the art. Some specific examples of control agents can be or can include, but are not limited to, 1,2-diether organic compounds, magnesium oxide, glycerol esters, ethoxylated amines (e.g., N,N-bis(2-hydroxyethyl) octadecylamine), alkyl sulfonates, and alkoxylated fatty acid esters, chromium N-oleylanthranilate salts, calcium salts of a Medialan acid and di-tert-butylphenol, an α-olefin-acrylonitrile copolymer and polymeric polyamine, sorbitan-monooleate, glycerol monostearate, methyl toluate, dimethyl maleate, dimethyl furnarate, triethylamine, 3,3-diphenyl-3-(imidazol-1-yl)-propin, and like compounds. In some embodiments, another continuity additive can include a metal carboxylate salt, optionally, with other compounds.

In some embodiments, the continuity additive can include an extracted metal carboxylate salt can be combined with an amine containing agent such an extracted carboxylate metal salt. For example, the extracted metal carboxylate salt can be combined with antistatic agents such as fatty amines, such as a blend of ethoxylated stearyl amine and zinc stearate, or a blend of ethoxylated stearyl amine, zinc stearate and octadecyl-3,5-di-tert-butyl-4-hydroxyhydrocinnamate.

Other continuity additives can include ethyleneimine additives such as polyethylenimines having the following general formula: —(CH₂—CH₂—NH)n-, where n can be from 10 to 10,000. The polyethyleneimines can be linear, branched, or hyper branched (e.g., forming dendritic or arborescent polymer structures). The polyethyleneimines can be a homopolymer or copolymer of ethyleneimine or mixtures thereof (referred to as polyethyleneimine(s) hereafter). Although linear polymers represented by the chemical formula-(CH₂—CH₂—NH)n- can be used as the polyethyleneimine, materials having primary, secondary, and tertiary branches can also be used.

### End Uses

The polymers produced by the processes disclosed herein and blends thereof can be useful in forming operations such as film, sheet, and fiber extrusion and co-extrusion as well as blow molding, injection molding, and rotary molding. Films include blown or cast films formed by co-extrusion or by lamination useful as shrink film, cling film, stretch film, scaling films, oriented films, snack packaging, heavy duty bags, grocery sacks, baked and frozen food packaging, medical packaging, industrial liners, membranes, etc., in food-contact and non-food contact applications. Fibers include melt spinning, solution spinning and melt blown fiber operations for use in woven or non-woven form to make filters, diaper fabrics, medical garments, geotextiles, etc. Extruded articles include medical tubing, wire and cable coatings, pipe, geomembranes, and pond liners. Molded articles include single and multi-layered constructions in the form of bottles, tanks, large hollow articles, rigid food containers and toys, etc.

Specifically, any of the foregoing polymers, such as ethylene copolymers or blends thereof, can be used in mono- or multi-layer blown, extruded, and/or shrink films. These films may be formed by any number of well-known extrusion or coextrusion techniques, such as a blown bubble film processing technique, wherein the composition can be extruded in a molten state through an annular die and then expanded to form a uni-axial or biaxial orientation melt prior to being cooled to form a tubular, blown film, which can then be axially slit and unfolded to form a flat film. Films may be subsequently unoriented, uniaxially oriented, or biaxially oriented to the same or different extents.

The polymers produced herein may be further blended with one or more second polymers and used in film, molded part and other typical applications. In one embodiment, the second polymer can be selected from ethylene homopolymer, ethylene copolymers, and blends thereof. Useful second ethylene copolymers can include one or more comonomers in addition to ethylene and can be a random copolymer, a statistical copolymer, a block copolymer, and/or blends thereof. The process of making the second ethylene polymer is not critical, as it can be made by slurry, solution, gas phase, high pressure or other suitable processes, and by using catalyst systems appropriate for the polymerization of polyethylene, such as Ziegler-Natta-type catalysts, chromium catalysts, metallocene-type catalysts, other appropriate catalyst systems or combinations thereof, or by free-radical polymerization.

### Characterization of Dual-Component Catalyst in Slurry

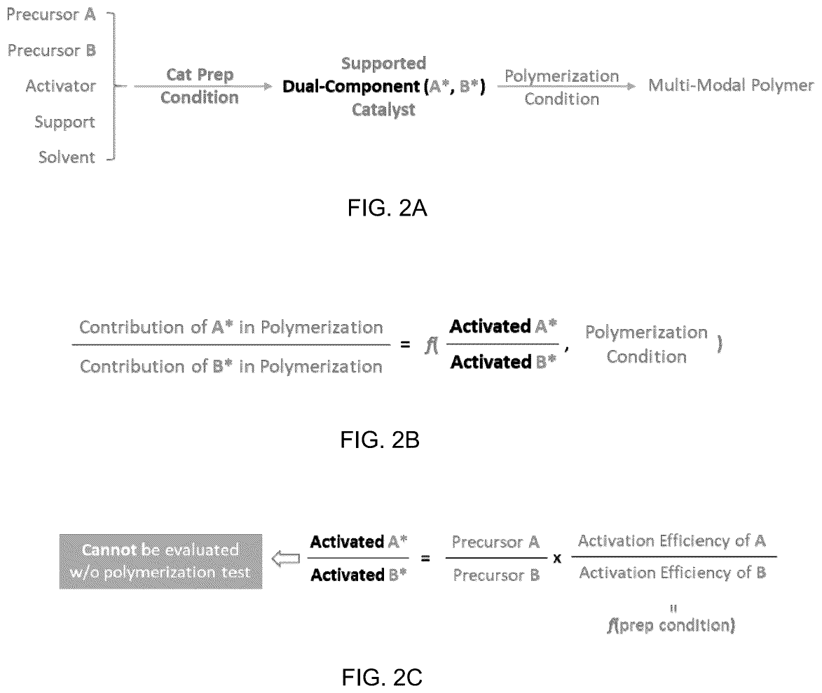

As discussed above, the mole ratio of the two types of active sites on the dual-component catalyst do not necessarily equal the mole ratio of the two catalyst precursors used in the preparation of the supported catalyst due to the different activation energies and activation efficiencies. FIG. 2A illustrates an example method of producing a dual-component catalyst and using the dual-component catalyst in a production of a multi-modal polymer. FIG. 2B illustrates the contribution in polymerization of the two types of active sites in a dual-component catalyst. FIG. 2C illustrates the relationship between the mole ratio of the two types of active sites in the dual-component catalyst and the mole ratio of the two type of catalyst precursors used in making the dual-component catalyst. From FIGS. 2A-C, it is apparent that the relative contribution in polymerization between the two types of active sites (i.e. composition of the resulting multi-modal polymer) depends on the mol ratio of the two types of active sites on supported catalyst. The assessment of the mole ratio of the two types of active sites in the dual-component catalyst has relied solely on polymerization testing.

In embodiments, it is assumed that for a particular type of active site, the spectral characteristics of the active sites remain the same with or without the presence of a second type of active site. This assumption enables the spectrum of the supported dual-component catalyst to be considered as a linear combination of the spectra of the individual active sites. FIG. 4 is a scheme for UV-Vis, steady-state emission, and time-resolve emission spectra of a supported dual component catalyst which shows that linear deconvolution can be used to characterize the supported dual-component catalyst and predict the relative contribution of each active site in polymerization. The spectrum of each type of active site can be readily characterized with the corresponding supported single-component catalyst. When there is sufficient spectral difference between the two types of active sites, an optimal fit for the spectrum of a dual-component catalyst can be mathematically identified by optimizing the ratio of the two single-component spectra.

In the spectral analysis of the dual-component catalyst, it is expected that the optimized ratio (that is a/b) of the two single-component spectra is proportional, but not necessarily equal, to the mol ratio of the two types of active sites on dual-component catalyst. This is because in the single-component catalyst, the exact concentration of the corresponding active site is not readily quantifiable. In addition, the response coefficients for the two types of active sites may differ, such as the extinction coefficient for absorption spectroscopy or quantum yield for emission spectroscopy are typically not equal for the two types of active sites. However, the catalyst performance in a polymerization reactor can still be predicted by the ratio of the spectra as the ratio of the spectra directly correlates to the relative quantity of active sites in the dual-component catalyst, as long as the same two single-component spectra are used as the basis for spectral deconvolution. As will be explained in further detail in the Examples section below, the above approach is validated to work with supported dual-metallocene catalyst using the spectral deconvolution approach. For dual-metallocene catalysts, the spectral deconvolution approach consistently yields good agreement between the experimental and the fitted spectra, enabling the description of active sites' composition with the ratio of the two single-component spectra.

### In-Line Monitoring of Dual-Component Catalyst in Slurry

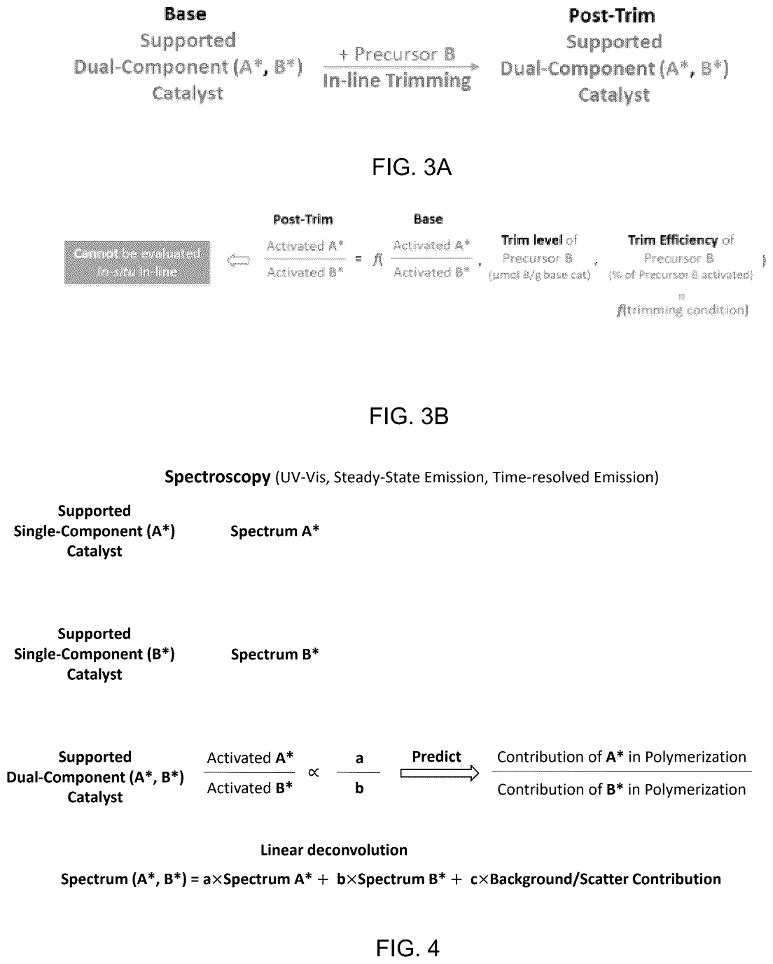

In-line monitoring of dual-component catalyst composition is highly desirable in processes where the catalyst composition can be adjusted in-line. One example of such process is the in-line trimming as described in FIG. 1 above. The in-line trimming process allows the base catalyst to react with one precursor, yielding a post-trim catalyst that features a different ratio of the two types of active sites prior to entering the gas phase reactor. FIG. 3A illustrates a production scheme for a post-trim catalyst. FIG. 3B illustrates that the relative ratio of the two types of active sites A* and B* in a post-trim catalyst, depends on the original ratio in base catalyst, the trim level (the amount of precursor B trimmed per gram of base catalyst), and the trim efficiency (the % of trimmed precursor B that was activated). In general, the trim efficiency is highly dependent on the in-line trimming condition, which is difficult to control and therefore difficult to accurately predict and control the ratio of the active sites in the post-trim catalyst. The capability to monitor post-trim catalyst composition in-line is highly desirable, because it allows early detection of any unexpected deviation in post-trim catalyst composition, preventing off-spec resin production.

### Optical Probe

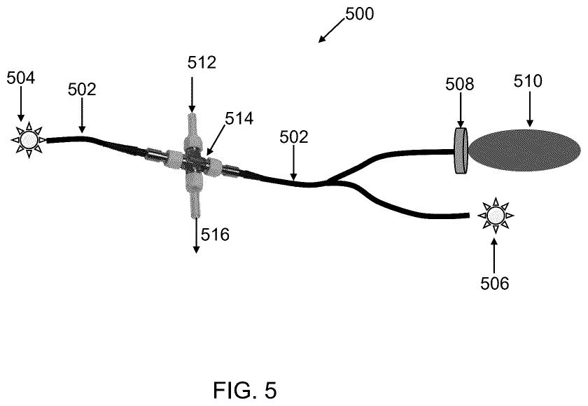

As discussed above, optic probe 150 is used in line to characterize the post-trim catalyst. The optic probe comprises a tunable light source to illuminate the post-trim catalyst in-line and further comprises a detector to measure the spectra of the post-trim catalyst. FIG. 5 is an example optic probe 500 that enables in-line measurements of UV-Vis absorption, steady-state emission, time-resolved emission spectra, and time-resolved intensity decay (lifetime) of supported dual-component catalyst. The optic probe in FIG. 5 comprises two optic fibers 502, a continuum tunable light source 504 for UV-Vis spectrometry, a laser light source 506 for steady-state emission spectra or a pulsed laser light source for intensity decays, and time-resolved emission spectra, a removable long pass filter 508, and a detector 510 configured to detect UV-Vis range wavelengths such as wavelengths in the range of 200 nm to 1100 nm and laser light wavelengths such as wavelengths in the range of 400 nm to 1100 nm, for example. In case of continuum laser source, a detector is equipped with diffraction element (e.g. diffraction grading) and array type sensor allowing for wavelength resolved detection. The optic probe is configured to allow for a catalyst slurry stream 512 containing a supported catalyst to flow between two optic fibers into sample chamber 514 before the catalyst slurry stream is introduced into a gas phase reactor as shown by arrow 516. The in-line measurements of UV-Vis and steady-state emission spectra of the catalyst slurry stream are enabled by the use of appropriate light sources and a spectral detector. The distance between the two optic fibers can be varied to accommodate various flow rates of catalyst slurry and to allow for variable optical path. In embodiments, the distance between the fibers can vary from 0.1 mm to 10 mm, for example. Alternatively, from 0.1 mm to 0.5 mm, from 0.5 mm to 1 mm, from 1 mm to 5 mm, from 5 mm to 10 mm, or any ranges therebetween.

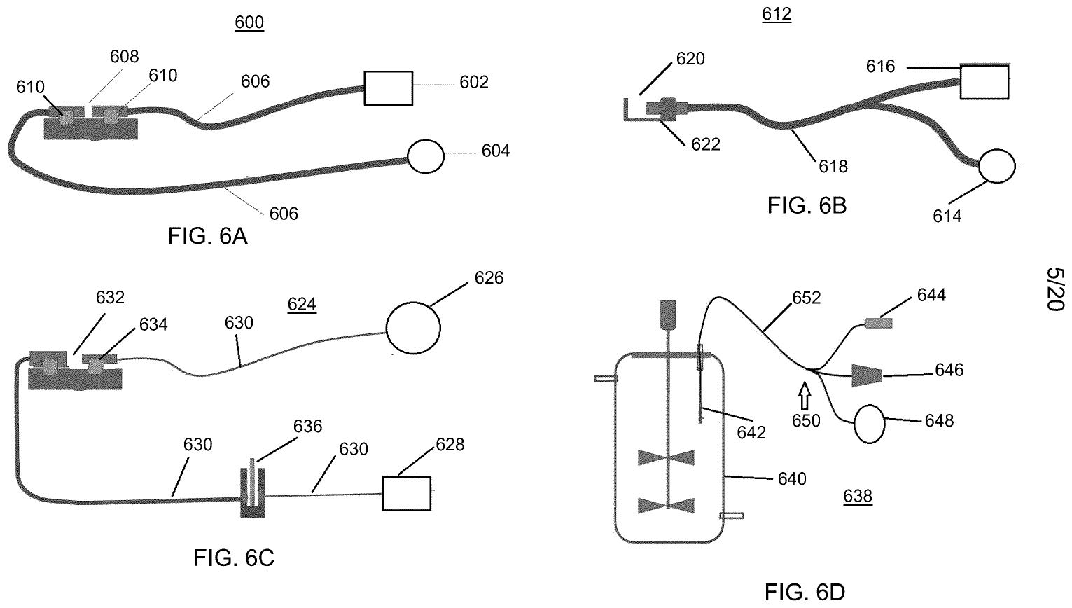

FIG. 6A is a schematic illustration of an optical probe 600. Optical probe 600 is configured for measurement of UV-Vis absorption. Optic probe 600 includes tunable light source 604 configured to output UV-Vis range light, detector 602, fiber optic 606, sample chamber 608, and optionally, movable holders 610. Fiber optic 606 is configured to transmit light generated in tunable light source 604 through sample chamber 608 and into detector 602. Sample chamber 608 is configured to hold a catalyst sample such as a cuvette containing catalyst in batch embodiments. Alternatively, sample chamber 608 is configured to allow for continuous flow of catalyst, such as post-trim catalyst as shown in FIG. 1 in continuous embodiments. In embodiments, movable holders 610 allow for adjustment of the size of sample chamber 608 to accommodate various optical paths, sizes of cuvettes or flow rate of catalyst slurry in continuous embodiments. In embodiments, light from tunable light source 604 travels through fiber optic 606 into sample chamber 608 where sample chamber 608 contains a catalyst slurry, such as a pre-trim catalyst slurry or a post-trim catalyst slurry. Light from tunable light source 604 illuminates the catalyst slurry in sample chamber 608 whereby a portion of the light may be attenuated by the catalyst slurry. The remaining portion of light which is not attenuated is transmitted through fiber optic 606 to detector 602 which is configured to measure the transmitted light to form a measured spectrum. A spectral deconvolution technique described herein is applied to the measured spectrum and the catalyst slurry is characterized.

FIG. 6B is a schematic illustration of optical probe 612. Optical probe 612 is configured for measurement of steady-state emission spectra (SS-EMS). Optic probe 612 includes tunable light source or laser 614, detector 616, fiber optic 618, sample chamber 620, and optionally, movable light blocker 622 or a mirror. Fiber optic 618 is configured to transmit light generated in tunable light source or laser 614 into sample chamber 620. Sample chamber 620 is configured to hold a catalyst sample such as a cuvette containing catalyst in batch embodiments. Alternatively, sample chamber 620 is configured to allow for continuous flow of catalyst, such as post-trim catalyst as shown in FIG. 1 in continuous embodiments. In embodiments, movable light blocker 622 allows to regulate the size of the optical path in sample chamber 620. In embodiments, light from tunable light source or laser 614 travels through fiber optic 618 into sample chamber 620 where sample chamber 620 contains a catalyst slurry, such as a pre-trim catalyst slurry or a post-trim catalyst slurry. Light from tunable light source or laser 614 illuminates the catalyst slurry in sample chamber 620 which excites fluorophores in the catalyst slurry and causes the fluorophores to emit light. The emission from the fluorophores in the catalyst are typically in the UV to visible range. The emitted light travels through fiber optic 618 to detector 616 which is configured to measure the emitted light to form a measured spectrum and/or time-resolved intensity decay (lifetime). A spectral deconvolution technique described herein is applied to the measured spectrum and the catalyst slurry is characterized. An analysis of time-resolved intensity decay is also described herein.

FIG. 6C is a schematic illustration of optical probe 624. Optical probe 624 is configured for measurement of UV-Vis spectra, steady-state emission spectra, time-gated emission spectra, and time-resolved emission intensity decay. Optic probe 624 includes light source 626, detector 628, fiber optic 630, sample chamber 632, optionally, movable holders 634, and optionally, light filter 636. In this embodiment, light source 626 can include a continuous wave laser or a pulsed lamp, or combinations of both. Alternatively or in addition to, light source 626 can include a tunable light source capable of outputting UV-Vis range light. Fiber optic 630 is configured to transmit light generated by light source 626 into sample chamber 632. Sample chamber 632 is configured to hold a catalyst sample such as a cuvette containing catalyst in batch embodiments. Alternatively, sample chamber 632 is configured to allow for continuous flow of catalyst, such as post-trim catalyst as shown in FIG. 1 in continuous embodiments. In embodiments, movable holders 634 allow to regulate the size of the optical path in sample chamber 632. In embodiments, light from light source 626 travels through fiber optic 630 into sample chamber 632 where sample chamber 632 contains a catalyst slurry, such as a pre-trim catalyst slurry or a post-trim catalyst slurry. Light from light source 626 illuminates the catalyst slurry in sample chamber 632 which excites fluorophores in the catalyst slurry and causes the fluorophores to emit radiation as described above. Additionally, a portion of the light may be attenuated by the catalyst slurry. The remaining portion of light which is not attenuated, or the emitted light from the fluorophores is transmitted through fiber optic 630 to detector 628 which is configured to measure the transmitted light and emitted light to form a measured spectrum. In embodiments, light filter 636 is placed between sample chamber 632 and detector 628 to reduce or eliminate scattered excitation light. A spectral deconvolution technique described herein is applied to the measured spectrum and the catalyst slurry is characterized.

FIG. 6D is a schematic illustration of a reactor system 638. Reactor system 638 includes a reactor vessel 640 and optic probe 650. Although reactor vessel 640 is illustrated as a continuously stirred tank reactor, reactor vessel 640 can include any type of reactor, including, without limitation, batch reactors, fluidized reactors, plug flow reactors, semi-batch reactors, and moving bed reactors, for example. Optic probe 650 includes laser light source 644, detector 646, tunable light source 648 configured to output UV-Vis range light, fiber optic 652, and sample chamber 642. In this embodiment, laser light source 644 can include a continuous wave laser, a pulsed laser light source, lamp, pulsed lamp, or combinations of them. Fiber optic 652 is configured to transmit light generated by light laser source 644 or the light from tunable light source 648 into sample chamber 642. Sample chamber 642 is configured allow reactor slurry in reactor vessel 640 to be exposed to light transmitted by fiber optic 652. For example, sample chamber 642 is configured to allow light to pass through sample chamber 642 and back into fiber optic 652 to measure UV-Vis transmittance. Alternatively, sample chamber 642 is configured to allow the slurry sample to receive excitation light from laser light source, and allow the emission light from fluorophores, (either as fluorescence and/or phosphorescence) in the reactor slurry into enter the detector 646 through fiber optic 652. The light from transmittance and excitation travels through fiber optic 652 back to detector 646 to form a measured spectrum. A spectral deconvolution technique described herein is applied to the measured spectrum and the catalyst slurry is characterized. For pulsed excitation intensity decay analyses herein is applied to retrieve lifetime components or/and time-resolved spectra.

### Additional Embodiments

Accordingly, the present disclosure may provide methods of spectroscopic characterization methods for supported catalyst in slurry. The methods and systems may include any of the various features disclosed herein, including one or more of the following statements.
Statement 1. A method comprising: preparing a slurry catalyst mixture comprising a multi-modal catalyst and a carrier fluid, wherein the multi-modal catalyst comprises a first activated catalyst and a second activated catalyst; introducing the slurry catalyst mixture into a sample chamber, optionally wherein the slurry catalyst mixture is continuously introduced into the sample chamber; illuminating the slurry catalyst mixture in the sample chamber with light generated from a light source; capturing a spectrum of the slurry catalyst mixture using a detector, wherein the spectrum comprises at least one spectrum selected from the group consisting of UV-Vis spectrum, emission spectrum, and combinations thereof; and determining a calculated ratio of an amount of the first activated catalyst and an amount of the second activated catalyst in the multi-modal catalyst from the spectrum of the slurry catalyst mixture by fitting the spectrum of the slurry catalyst mixture to a single component spectrum of the first activated catalyst and a single component spectrum of the second activated catalyst, using spectral deconvolution; optionally wherein the determining is carried out on the basis of continuously introduced slurry catalyst mixture in the sample chamber. The method further optionally can include adjusting the amount of first activated catalyst and/or the amount of second activated catalyst in the multi-modal catalyst and/or slurry catalyst mixture based at least in part upon the calculated ratio.
Statement 2. The method of statement 1, wherein the slurry catalyst mixture further comprises a third activated catalyst and/or a fourth activated catalyst, and wherein the method further comprises fitting the spectrum of the slurry catalyst mixture to a single component spectrum of the third activated catalyst and/or a single component spectrum of the fourth activated catalyst, using spectral deconvolution. The method of Statement 2 further optionally can include adjusting the amount of first, second, third, and/or fourth activated catalyst in the slurry catalyst mixture based at least in part upon the calculated ratio.
Statement 3. The method of any of statements 1-2 wherein the light source outputs light from 200-900 nm and wherein the detector is configured to capture the UV-Vis spectrum.
Statement 4. The method of any of statements 1-3 wherein the light source comprises a laser and the detector is configured to capture the emission spectrum.
Statement 5. The method of any of statements 1-4 wherein the light source comprises a pulsed light source or intensity modulated light source and wherein the spectrum comprise a time-resolved response of fluorescence and/or phosphorescence lifetimes of the catalyst slurry mixture.
Statement 6. The method of any of statements 1-5 further comprising one or more of subtracting background contribution from the spectrum, subtracting scattering contribution from the spectrum, or normalizing the spectrum, to form a modified spectrum wherein the modified spectrum is used in the spectral deconvolution.
Statement 7. The method of any of statements 1-6 wherein the slurry catalyst mixture comprises a contact product of a first catalyst, a second catalyst, a support, an activator, and the carrier fluid, wherein the support comprises silica, wherein the activator comprises an aluminoxane, wherein the carrier fluid comprises mineral oil or mixture of mineral oils, wherein the first catalyst and the second catalyst each comprise a metallocene or a non-metallocene catalyst, and, wherein the activator activates at least a portion of the first catalyst to produce the first activated catalyst and wherein the activator activates at least a portion of the second catalyst to produce the second activated catalyst.
Statement 8. The method of statement 7 wherein the first catalyst comprises a hafnocene, preferably a bridged hafnocene, such as a bridged bis-cyclopentadienyl hafnocene, most preferably one or more of rac/meso Me₂Si(Me₃SiCH₂Cp)₂HfMe₂; racMe₂Si(Me₃SiCH₂Cp)₂HfMe₂; rac/meso Ph₂Si(Me₃SiCH₂Cp)₂HfMe₂; rac/meso (CH₂)₃Si(Me₃SiCH₂Cp)₂HfMe₂; rac/meso (CH₂)₃Si(Me₃SiCH₂Cp)₂HfMe₂; rac/meso (C₆F₅)₂Si(Me₃SiCH₂Cp)₂HfMe₂; rac/meso (CH₂)₃Si(Me₃SiCH₂Cp)₂ZrMe₂; rac/meso Me₂Ge(Me₃SiCH₂Cp)₂HfMe₂; rac/meso Me₂Si(Me₂PhSiCH₂Cp)₂HfMe₂; rac/meso Ph₂Si(Me₂PhSiCH₂Cp)₂HfMe₂; and Me₂Si(MeCp)(Me₂PhSiCH₂Cp)HfMe₂; and wherein the second catalyst comprises a zirconocene, preferably an unbridged zirconocene, such as a an unbridged indenyl-cyclopentadienyl zirconocene, most preferably one or more of bis(indenyl)zirconium dichloride, bis(indenyl)zirconium dimethyl, bis(tetrahydro-1-indenyl)zirconium dichloride, bis(tetrahydro-1-indenyl)zirconium dimethyl, rac/meso-bis(1-ethylindenyl)zirconium dichloride, rac/meso-bis(1-ethylindenyl)zirconium dimethyl, rac/meso-bis(1-methylindenyl)zirconium dichloride, rac/meso-bis(1-methylindenyl)zirconium dimethyl, rac/meso-bis(1-propylindenyl)zirconium dichloride, rac/meso-bis(1-propylindenyl)zirconium dimethyl, rac/meso-bis(1-butylindenyl)zirconium dichloride, rac/meso-bis(1-butylindenyl)zirconium dimethyl, meso-bis(1ethylindenyl)zirconium dichloride, meso-bis(1-ethylindenyl)zirconium dimethyl, (1-methylindenyl)(pentamethyl cyclopentadienyl)zirconium dichloride, (1-methylindenyl)(pentamethyl cyclopentadienyl)zirconium dimethyl.
Statement 9. A method comprising: providing an optical probe, the optical probe comprising a light source, a detector, and an optic fiber, wherein the optic fiber is configured to transmit light emitted from the light source to a sample chamber and wherein the optic fiber is further configured to transmit light from the sample chamber to the detector; preparing a slurry catalyst mixture comprising a multi-modal catalyst and a carrier fluid, wherein the multi-modal catalyst comprises a first activated catalyst and a second activated catalyst; continuously feeding the slurry catalyst mixture into the sample chamber; illuminating the slurry catalyst mixture in the sample chamber with light generated from the light source, while continuously feeding the slurry catalyst mixture into the sample chamber; capturing a spectrum of the continuously fed slurry catalyst mixture using a detector, wherein the spectrum comprises at least one spectrum selected from the group consisting of UV-Vis spectrum, emission spectrum, and combinations thereof; and determining a calculated ratio of an amount of the first activated catalyst and an amount of the second activated catalyst in the multi-modal catalyst from the spectrum of the slurry catalyst mixture by fitting the spectrum of the slurry catalyst mixture to a single component spectrum of the first activated catalyst and a single component spectrum of the second activated catalyst, using spectral deconvolution. The method further optionally can include adjusting the amount of first activated catalyst and/or the amount of second activated catalyst in the multi-modal catalyst based at least in part upon the calculated ratio.
Statement 10. The method of statement 9 wherein the slurry catalyst mixture further comprises a third activated catalyst and/or a fourth activated catalyst, and wherein the method further comprises fitting the spectrum of the slurry catalyst mixture to a single component spectrum of the third activated catalyst and/or a single component spectrum of the fourth activated catalyst, using spectral deconvolution. The method of Statement 10 further optionally can include adjusting the amount of first, second, third, and/or fourth activated catalyst in the slurry catalyst mixture based at least in part upon the calculated ratio.
Statement 11. The method of any of statements 9-10 wherein the light source outputs light from 200-900 nm and wherein the detector is configured to capture the UV-Vis spectrum.
Statement 12. The method of any of statements 9-11 wherein the light source comprises a laser and the detector is configured to capture the emission spectrum.
Statement 13. The method of any of statements 9-12 wherein the light source comprises a pulsed light source or intensity modulated light source and wherein the spectrum comprise a time-resolved response of fluorescence and/or phosphorescence lifetimes of the catalyst slurry mixture.
Statement 14. The method of any of statements 9-13 further comprising at least one of subtracting background contribution from the spectrum, subtracting scattering contribution from the spectrum, or normalizing the spectrum, to form a modified spectrum wherein the modified spectrum is used in the spectral deconvolution.
Statement 15. The method of any of statements 9-14 wherein the slurry catalyst mixture comprises a contact product of a first catalyst, a second catalyst, a support, an activator, and the carrier fluid, wherein the support comprises silica, wherein the activator comprises an aluminoxane, wherein the carrier fluid comprises mineral oil or mixture of mineral oils, wherein the first catalyst and the second catalyst each comprise a metallocene or a non-metallocene catalyst, and, wherein the activator activates at least a portion of the first catalyst to produce the first activated catalyst and wherein the activator activates at least a portion of the second catalyst to produce the second activated catalyst.
Statement 16. The method of statement 15 wherein the first catalyst comprises a hafnocene, preferably a bridged hafnocene, such as a bridged bis-cyclopentadienyl hafnocene, most preferably or more one of rac/meso Me₂Si(Me₃SiCH₂Cp)₂HfMe₂; racMe₂Si(Me₃SiCH₂Cp)₂HfMe₂; rac/meso Ph₂Si(Me₃SiCH₂Cp)₂HfMe₂; rac/meso (CH₂)₃Si(Me₃SiCH₂Cp)₂HfMe₂; rac/meso (CH₂)₃Si(Me₃SiCH₂Cp)₂HfMe₂; rac/meso (C₆F₅)₂Si(Me₃SiCH₂Cp)₂HfMe₂; rac/meso (CH₂)₃Si(Me₃SiCH₂Cp)₂ZrMe₂; rac/meso Me₂Ge(Me₃SiCH₂Cp)₂HfMe₂; rac/meso Me₂Si(Me₂PhSiCH₂Cp)₂HfMe₂; rac/meso Ph₂Si(Me₂PhSiCH₂Cp)₂HfMe₂; and Me₂Si(MeCp)(Me₂PhSiCH₂Cp)HfMe₂; and wherein the second catalyst comprises a zirconocene, preferably an unbridged zirconocene, such as a an unbridged indenyl-cyclopentadienyl zirconocene, most preferably one or more of bis(indenyl)zirconium dichloride, bis(indenyl)zirconium dimethyl, bis(tetrahydro-1-indenyl)zirconium dichloride, bis(tetrahydro-1-indenyl)zirconium dimethyl, rac/meso-bis(1-ethylindenyl)zirconium dichloride, rac/meso-bis(1-ethylindenyl)zirconium dimethyl, rac/meso-bis(1-methylindenyl)zirconium dichloride, rac/meso-bis(1-methylindenyl)zirconium dimethyl, rac/meso-bis(1-propylindenyl)zirconium dichloride, rac/meso-bis(1-propylindenyl)zirconium dimethyl, rac/meso-bis(1-butylindenyl)zirconium dichloride, rac/meso-bis(1-butylindenyl)zirconium dimethyl, meso-bis(1ethylindenyl)zirconium dichloride, meso-bis(1-ethylindenyl)zirconium dimethyl, (1-methylindenyl)(pentamethyl cyclopentadienyl)zirconium dichloride, (1-methylindenyl)(pentamethyl cyclopentadienyl)zirconium dimethyl.
Statement 17. A method comprising: contacting a base catalyst mixture and a trim catalyst solution to form a contact product comprising a post-trim multimodal catalyst, wherein the base catalyst mixture comprises a first catalyst, a second catalyst, a support, an activator, and a carrier, wherein the trim catalyst solution comprises additional second catalyst, and a solvent, and wherein the post-trim bimodal catalyst comprises a first active catalyst corresponding to the first catalyst and a second active catalyst corresponding to the second catalyst; generating a spectrum of the post-trim multimodal catalyst; determining a calculated ratio of an amount of the first active catalyst and the second active catalyst in the post-trim multimodal catalyst from the spectrum of the post-trim multimodal catalyst by fitting the spectrum of the post-trim multimodal catalyst to a single component spectrum of the first active catalyst and a single component spectrum of the second active catalyst using spectral deconvolution; comparing the calculated ratio to a target ratio of the first active catalyst and the second active catalyst in the post-trim multimodal catalyst and adjusting a flow rate of the trim catalyst solution such that the calculated ratio of amount of the first active catalyst and the second active catalyst in the post-trim multimodal catalyst is closer to the target ratio; introducing the post-trim multimodal catalyst and one or more olefins into a polymerization reactor; and polymerizing the one or more olefins in the presence of the post-trim multimodal catalyst to produce a polymer product.
Statement 18. The method of statement 17 wherein the support comprises silica, wherein the activator comprises an aluminoxane, wherein the first catalyst and the second catalyst each comprise a metallocene or a non-metallocene catalyst.
Statement 19. The method of any of statements 17-18 wherein the spectrum comprises a UV-Vis spectrum and wherein generating the spectrum comprises illuminating the post-trim multimodal catalyst with a light source which outputs light from 200-900 nm.
Statement 20. The method of any of statements 17-19 wherein the spectrum comprises an emission spectrum and wherein generating the spectrum comprises illuminating the post-trim multimodal catalyst with a laser.
Statement 21. The method of statement 20 wherein the laser comprises a pulsed laser light source or intensity modulated laser light source and wherein the spectral deconvolution comprises calculating a time-resolved response and/or a time-gated response of fluorescence and/or phosphorescence lifetimes of the post-trim multimodal catalyst.
Statement 22. The method of statement 21 wherein the calculated ratio of the amount of the first active catalyst and the second active catalyst in the post-trim multimodal catalyst is determined from the time-resolved and/or the time-gated response of the post-trim multimodal catalyst by fitting emission spectrum lifetimes and/or time-resolved spectra of the post-trim multimodal catalyst to a single component spectrum response of the first active catalyst and a single component spectrum response of the second active catalyst.
Statement 23. The method of any of statements 17-22 wherein the first catalyst comprises a hafnocene, preferably a bridged hafnocene, such as a bridged bis-cyclopentadienyl hafnocene, most preferably one or more of rac/meso Me₂Si(Me₃SiCH₂Cp)₂HfMe₂; racMe₂Si(Me₃SiCH₂Cp)₂HfMe₂; rac/meso Ph₂Si(Me₃SiCH₂Cp)₂HfMe₂; rac/meso (CH₂)₃Si(Me₃SiCH₂Cp)₂HfMe₂; rac/meso (CH₂)₃Si(Me₃SiCH₂Cp)₂HfMe₂; rac/meso (C₆F₅)₂Si(Me₃SiCH₂Cp)₂HfMe₂; rac/meso (CH₂)₃Si(Me₃SiCH₂Cp)₂ZrMe₂; rac/meso Me₂Ge(Me₃SiCH₂Cp)₂HfMe₂; rac/meso Me₂Si(Me₂PhSiCH₂Cp)₂HfMe₂; rac/meso Ph₂Si(Me₂PhSiCH₂Cp)₂HfMe₂; and Me₂Si(Me₄Cp)(Me₂PhSiCH₂Cp)HfMe₂; and wherein the second catalyst comprises a zirconocene, preferably an unbridged zirconocene, such as a an unbridged indenyl-cyclopentadienyl zirconocene, most preferably one or more of bis(indenyl)zirconium dichloride, bis(indenyl)zirconium dimethyl, bis(tetrahydro-1-indenyl)zirconium dichloride, bis(tetrahydro-1-indenyl)zirconium dimethyl, rac/meso-bis(1-ethylindenyl)zirconium dichloride, rac/meso-bis(1-ethylindenyl)zirconium dimethyl, rac/meso-bis(1-methylindenyl)zirconium dichloride, rac/meso-bis(1-methylindenyl)zirconium dimethyl, rac/meso-bis(1-propylindenyl)zirconium dichloride, rac/meso-bis(1-propylindenyl)zirconium dimethyl, rac/meso-bis(1-butylindenyl)zirconium dichloride, rac/meso-bis(1-butylindenyl)zirconium dimethyl, meso-bis(1ethylindenyl)zirconium dichloride, meso-bis(1-ethylindenyl)zirconium dimethyl, (1-methylindenyl)(pentamethyl cyclopentadienyl)zirconium dichloride, (1-methylindenyl)(pentamethyl cyclopentadienyl)zirconium dimethyl.
Statement 24. The method of any of statements 17-23 further comprising one or more of subtracting background contribution from the spectrum, subtracting scattering contribution from the spectrum, or normalizing the spectrum, to form a modified spectrum wherein the modified spectrum is used in the spectral deconvolution.
Statement 25. The method of any of statements 17-24 wherein the contacting the base catalyst mixture and the trim catalyst solution occurs in a process feedline downstream from a tie-in point of the base catalyst mixture and the trim catalyst solution, to produce the post-trim multimodal catalyst.
Statement 26. The method of any of statements 17-25 wherein the contacting the base catalyst mixture and the trim catalyst solution takes place in a mixer fluidically coupled to a trim pot comprising the trim catalyst solution and a base catalyst mixture pot comprising the base catalyst mixture, wherein the mixer is configured to mix the base catalyst mixture and the trim catalyst solution to produce the post-trim multimodal catalyst.
Statement 27. A system comprising: a sample chamber configured to hold a post-trim multimodal catalyst mixture, wherein the post-trim multimodal catalyst mixture comprises a first activated catalyst and a second activated catalyst, wherein the post-trim multimodal catalyst mixture is produced by contacting a base catalyst mixture and a trim catalyst solution to form a contact product comprising a post-trim multimodal catalyst, wherein the base catalyst mixture comprises a first catalyst, a second catalyst, a support, an activator, and a carrier, wherein the trim catalyst solution comprises additional second catalyst, and a solvent, and wherein the post-trim bimodal catalyst comprises a first active catalyst corresponding to the first catalyst and a second active catalyst corresponding to the second catalyst; an optical probe configured to illuminate the post-trim multimodal catalyst mixture in the sample chamber and generate a spectrum of the post-trim multimodal catalyst mixture; and a control system configured to: receive the spectrum; determine a calculated ratio of an amount of the first activated catalyst and the second activated catalyst in the post-trim multimodal catalyst mixture from the spectrum of the post-trim multimodal catalyst mixture by fitting the spectrum of the post-trim multimodal catalyst mixture to a single component spectrum of the first activated catalyst and a single component spectrum of the second activated catalyst using spectral deconvolution; compare the calculated ratio of the amount of the first activated catalyst and the second activated catalyst in the multimodal catalyst to a set point ratio of the amount of the first activated catalyst and the second activated catalyst in the multimodal catalyst; and adjust a flow rate of a trim catalyst solution such that the calculated ratio of amount of the first active catalyst and the second active catalyst in the post-trim multimodal catalyst is closer to the set point ratio.
Statement 28. The system of statement 27 wherein the control system is further configured to perform one or more of subtracting background contribution from the spectrum, subtracting scattering contribution from the spectrum, or normalizing the spectrum, to form a modified spectrum wherein the modified is used in the spectral deconvolution.
Statement 29. The system of any of claims 27-28 wherein the optical probe outputs light from 200-900 nm and wherein the spectrum is a UV-Vis spectrum.
Statement 30. The system of any of claims 27-29 wherein the optical probe comprises a laser and wherein the spectrum is an emission spectrum.
Statement 31. The system of any of claims 27-30 wherein the optical probe comprises a pulsed light source or intensity modulated light source and wherein the spectrum comprises a time-resolved response of fluorescence and/or phosphorescence lifetimes of the post-trim multimodal catalyst.
Statement 32. The system of any of claims 27-31 wherein the post-trim multimodal catalyst comprises a support comprising silica, an activator comprising an aluminoxane, and two metallocene catalysts.
Statement 33. The system of statement 32 wherein the two metallocene catalysts comprise (1) a hafnocene, preferably a bridged hafnocene, such as a bridged bis-cyclopentadienyl hafnocene, most preferably one or more of rac/meso Me₂Si(Me₃SiCH₂Cp)₂HfMe₂;
racMe₂Si(Me₃SiCH₂Cp)₂HfMe₂; rac/meso Ph₂Si(Me₃SiCH₂Cp)₂HfMe₂; rac/meso (CH₂)₃Si(Me₃SiCH₂Cp)₂HfMe₂; rac/meso (CH₂)₄Si(Me₃SiCH₂Cp)₂HfMe₂; rac/meso (C₆F₅)₂Si(Me₃SiCH₂Cp)₂HfMe₂; rac/meso (CH₂)₃Si(Me₃SiCH₂Cp)₂ZrMe₂; rac/meso Me₂Ge(Me₃SiCH₂Cp)₂HfMe₂; rac/meso Me₂Si(Me₂PhSiCH₂Cp)₂HfMe₂; rac/meso Ph₂Si(Me₂PhSiCH₂Cp)₂HfMe₂; and Me₂Si(Me₄Cp)(Me₂PhSiCH₂Cp)HfMe₂; and (2) a zirconocene, preferably an unbridged zirconocene, such as an unbridged indenyl-cyclopentadienyl zirconocene, most preferably one or more of bis(indenyl)zirconium dichloride, bis(indenyl)zirconium dimethyl, bis(tetrahydro-1-indenyl)zirconium dichloride, bis(tetrahydro-1-indenyl)zirconium dimethyl, rac/meso-bis(1-ethylindenyl)zirconium dichloride, rac/meso-bis(1-ethylindenyl)zirconium dimethyl, rac/meso-bis(1-methylindenyl)zirconium dichloride, rac/meso-bis(1-methylindenyl)zirconium dimethyl, rac/meso-bis(1-propylindenyl)zirconium dichloride, rac/meso-bis(1-propylindenyl)zirconium dimethyl, rac/meso-bis(1-butylindenyl)zirconium dichloride, rac/meso-bis(1-butylindenyl)zirconium dimethyl, meso-bis(1ethylindenyl)zirconium dichloride, meso-bis(1-ethylindenyl)zirconium dimethyl, (1-methylindenyl)(pentamethyl cyclopentadienyl)zirconium dichloride, (1-methylindenyl)(pentamethyl cyclopentadienyl) zirconium dimethyl.

To facilitate a better understanding of the present invention, the following examples of certain aspects of some embodiments are given. In no way should the following examples be read to limit, or define, the entire scope of the disclosure.

### EXAMPLES

### Example 1

In this example, a series of catalysts were prepared according to Table 1 below. A co-supported catalyst including various amounts of metallocene Precursor A and metallocene Precursor B were prepared on silica using 30 wt. % methylalumoxane (MAO) in toluene as the activator. The mole ratio of the precursors is shown in Table 1 as Precursor A/Precursor B. The solvent used for the process was anhydrous toluene. Two of the formulations, II (80/20 precursor ratio), and IV (60/40 precursor ratio) were prepared both at pilot and commercial scales.

TABLE 1

| | | |
|---|---|---|
| | | Precursor A |
| 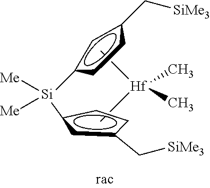 | 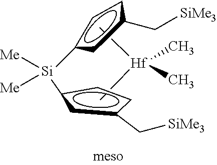 | |
| | | Precursor B |
| 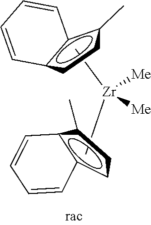 | 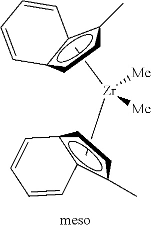 | |

| | | | | | | | | Total | |
|---|---|---|---|---|---|---|---|---|---|
| | | | | | 30 wt% | | MAO | MCN | |
| | | | Precursor | Precursor | MAO in | | loading | loading | Precursor |
| Prep | Formu- | Catalyst | A | B | toluene | Silica | (mmol/g | (mmol/g | ratio |
| Scale | lation | ID | (g) | (g) | (g) | (g) | catalyst) | catalyst) | A/B |
| Pilot | | Control | 0 | 0 | 1265 | 1058 | 4.5 | 0 | 0/0 |
| Pilot | I | Cat-1 | 8.96 | 0.00 | 1265 | 1058 | 4.4 | 0.011 | 100/0 |
| Pilot | II | Cat-2 | 11.32 | 1.89 | 1245 | 1034 | 4.5 | 0.018 | 80/20 |
| Pilot | III | Cat-3 | 10.19 | 2.77 | 1273 | 1043 | 4.5 | 0.018 | 70/30 |
| Pilot | IV | Cat-4 | 8.40 | 3.74 | 1178 | 980 | 4.5 | 0.018 | 60/40 |
| Pilot | IV | Cat-5 | 8.97 | 4.02 | 1250 | 1040 | 4.5 | 0.018 | 60/40 |
| Pilot | V | Cat-6 | 7.77 | 5.18 | 1239 | 1052 | 4.4 | 0.019 | 50/50 |
| Pilot | VI | Cat-7 | 6.41 | 6.46 | 1248 | 1034 | 4.5 | 0.020 | 40/60 |
| Pilot | VII | Cat-8 | 0.00 | 8.30 | 1290 | 1046 | 4.6 | 0.015 | 0/100 |
| Comm | II | B-1 | 4900 | 700 | 481240 | 399066 | 4.5 | 0.019 | 80/20 |
| Comm | IV | B4-21 | 3444 | 1490 | 480726 | 398640 | 4.5 | 0.018 | 60/40 |

### Example 2

In this Example, the catalyst from Example 1 were subjected to spectroscopy measurements. The sample preparation method includes mixing the active dry catalyst with a low-viscosity, chemically inert, and UV-Vis-transparent mineral oil. The mineral oil chosen was Carnation® white mineral oil from Sonneborn. The resulting slurry of catalyst and mineral oil was transferred to a 1 mm×10 mm quartz cuvette, sealed, and then centrifuged at 1200 rpm for 10 minutes to force the catalyst solids to settle at the bottom of the cuvette. This procedure consistently yielded a 1 mm-thick, translucent layer of settled supported catalyst in mineral oil for optic spectroscopy measurements. The entire preparation procedure was carried out in a dry box to prevent catalyst deactivation.

The prepared cuvette is taken out of the dry box and mounted in a sample holder in a Cary 60 UV-Visible Spectrophotometer (Agilent, Inc.). The position of the cuvette ensures that the light beam passes through the settled solid of the supported catalyst during UV-Vis measurement. UV-Vis absorption spectra are measured at room temperature, and Carnation® white mineral oil (CWMO) in 1 mm×10 mm cuvette serves as the baseline. The typical scan range is 200-800 nm.

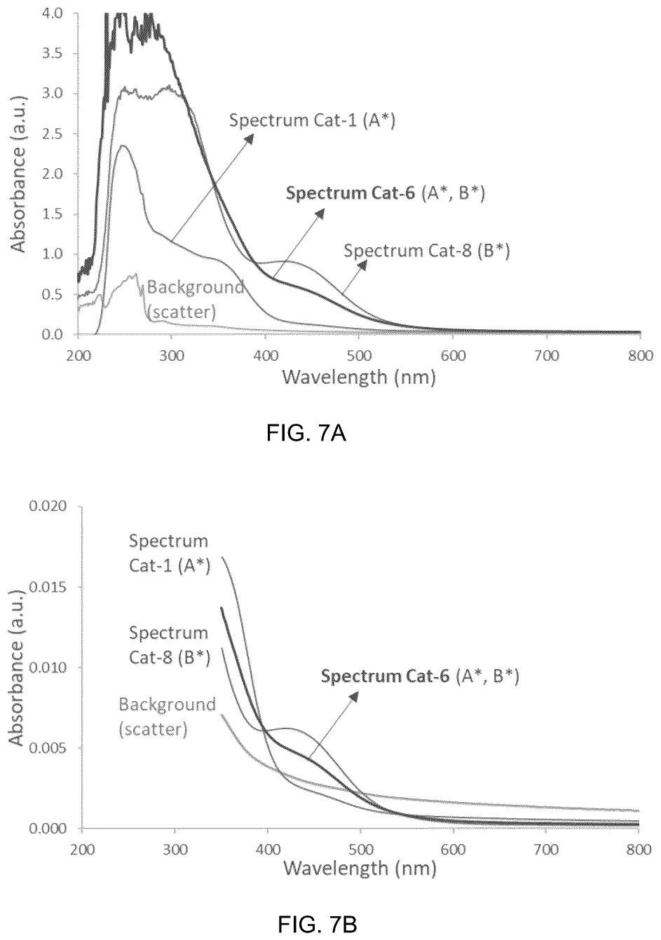

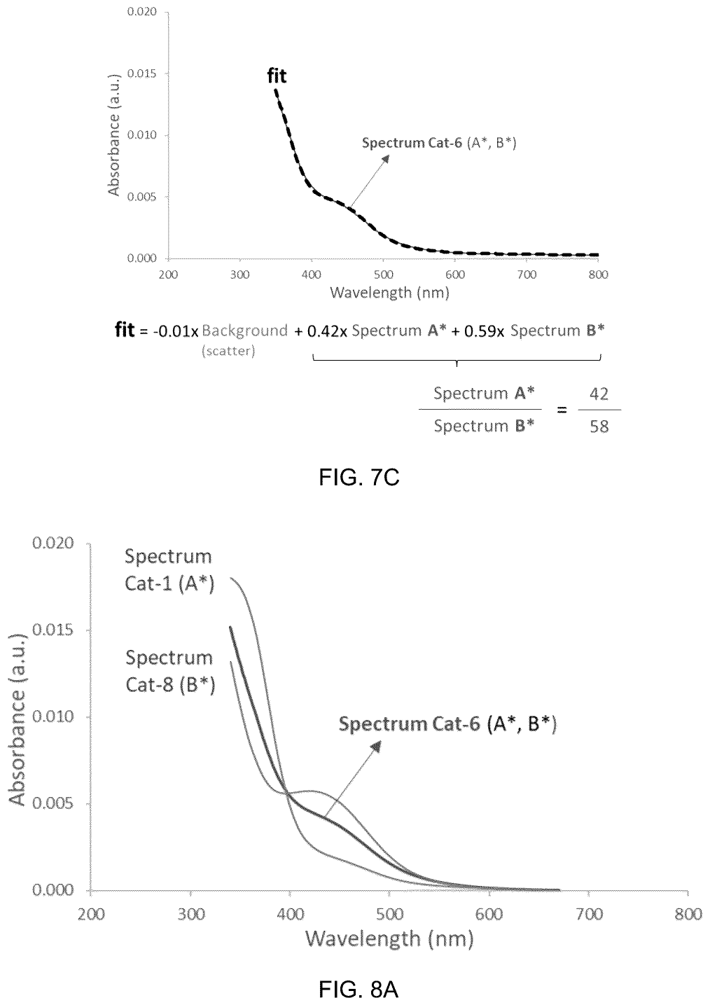

FIG. 7A is the as-measured (raw) UV-Vis spectra of the control (prepared with no metallocene precursor), Cat-1 (prepared with 100/0 precursor ratio), Cat-8 (prepared with 0/100 precursor ratio), and Cat-6 (prepared with 50/50 precursor ratio) with CMWO spectrum baseline. It can be observed in FIG. 7A that in the UV-region of the as-measured UV-Vis spectrum (i.e. <350 nm), the supported catalyst typically features >2 absorbance (i.e. >99% of light is absorbed or scattered). It can be observed in the as measured UV-Vis spectrum of the control, the contribution of background (scatter) is typically lower than 0.1 absorbance in the wavelength region of 350-800 nm. For data analysis purposes, it is satisfactory to focus on the range between 350-800 nm.

A normalization protocol is applied to the spectra in FIG. 7A such that the area under the UV-Vis curve in the 350-800 nm range is equal to 1 as shown in FIG. 7B. The normalized spectrum of Cat-6 can be mathematically fitted by a linear combination of three components: the normalized control spectrum (background/scattering), the normalized spectrum of Cat-1 (single-component activated precursor A), and the normalized spectrum of Cat-8 (single-component activated precursor B). The best fit is identified by minimizing the sum of the squares of offsets (residual) between the normalized UV-Vis spectrum of Cat-6 and the fitted curve of the linear combination of the normalized control spectrum (background/scattering), the normalized spectrum of Cat-1 (single-component activated precursor A), and the normalized spectrum of Cat-8 (single-component activated precursor B). FIG. 7C shows that the normalized spectrum of Cat-6 is best described by a combination of 42% the normalized spectrum of Cat-1 (single-component activated precursor A) and 58% the normalized spectrum of Cat-8 (single-component activated precursor B). The above fitting protocol can also be performed on raw (as-measured) absorption spectra, though an adequate correction factor may need to be applied.

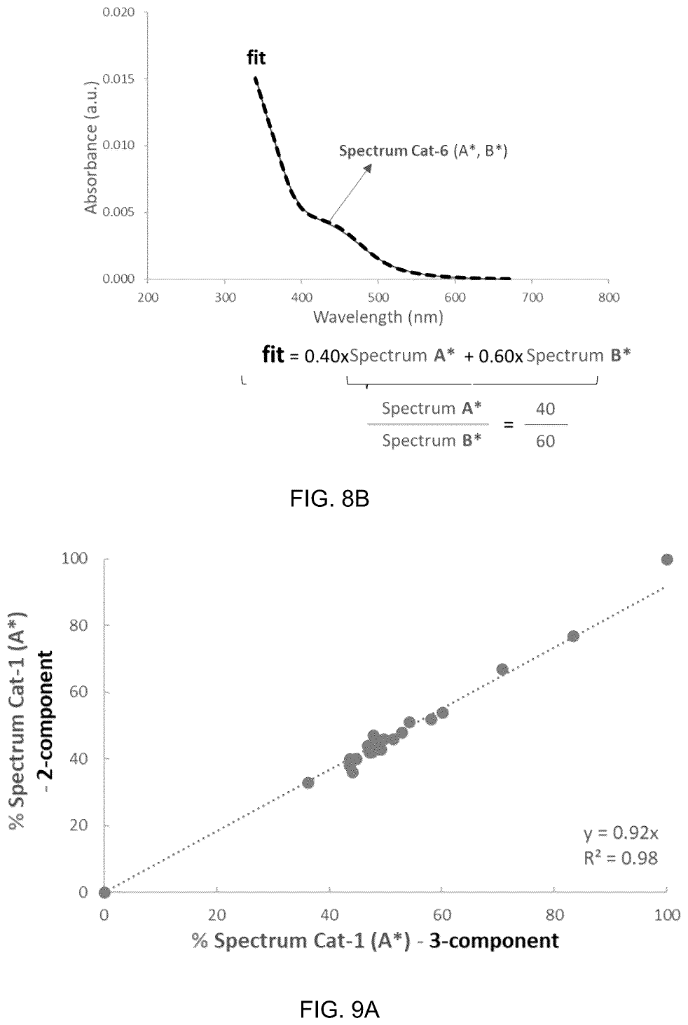

The above 3-component deconvolution method can be simplified to a 2-component deconvolution method. By subtracting the as-measured spectrum of the control from the as measured spectra of Cat-1, Cat-8, and Cat-6, the contribution of the background/scattering is removed. A normalization protocol is then applied to the scatter-removed spectra of Cat-1, Cat-8, and Cat-6, such that the area under the UV-Vis curve in the 350-670 nm range is equal to 1 as shown in FIG. 8A. The normalized spectrum of Cat-6 can be mathematically fitted by a linear combination of two components: the normalized spectrum of Cat-1 (single-component activated precursor A), and the normalized spectrum of Cat-8 (single-component activated precursor B). The best fit is identified by minimizing the sum of the squares of offsets (residual) between the normalized UV-Vis spectrum of Cat-6 and the fitted curve of the linear combination of the normalized spectrum of Cat-1 (single-component activated precursor A), and the normalized spectrum of Cat-8 (single-component activated precursor B). FIG. 8B shows that the normalized spectrum of Cat-6 is best described by a combination of 40% the normalized spectrum of Cat-1 (single-component activated precursor A) and 60% the normalized spectrum of Cat-8 (single-component activated precursor B). The above fitting protocol can also be performed on raw (as-measured) absorption spectra, though an adequate correction factor may need to be applied.

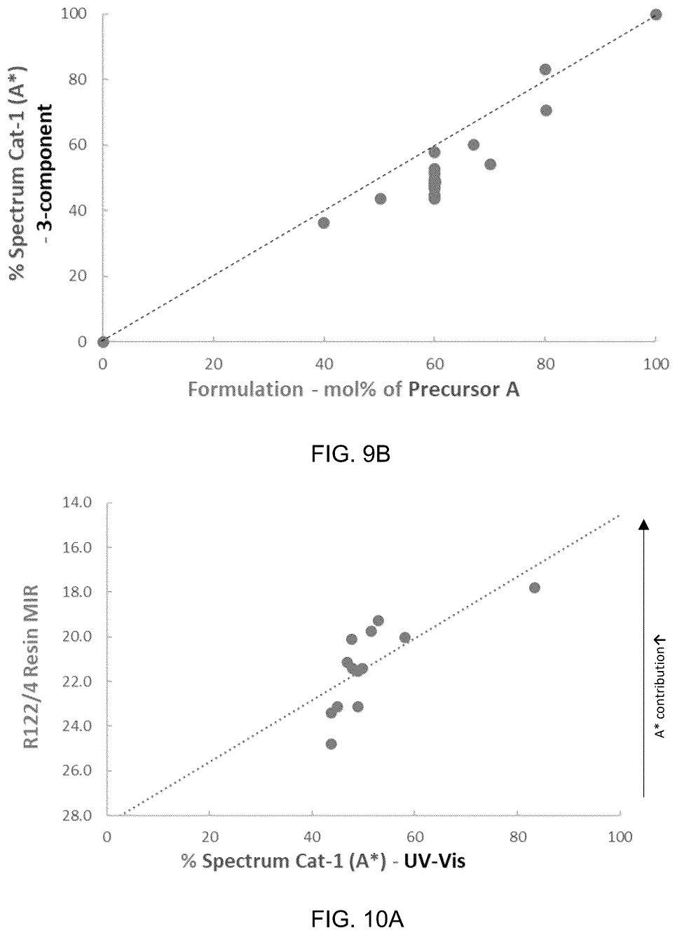

The above 3-component deconvolution method and the 2-component deconvolution methods were applied to the catalysts from Table 1, which include 8 catalysts prepared at pilot plant scale and 19 catalysts prepared at commercial scale. The result of the spectral deconvolution is shown in Table 2. It was observed that the two different deconvolution methods offers comparable results as shown in FIG. 9A.

TABLE 2

| | | | | | Polymerization Testing Result | |
|---|---|---|---|---|---|---|
| | | | UV-Vis Spectral Deconvolution | | | Lab batch |
| | | | % Spectrum | % Spectrum | | Reactor: End- |
| Prep | | Catalyst | Cat-1 (A*) | Cat-1 (A*) | Pilot Plant: | of-run H2/C2 |
| Scale | Formulation | ID | 3-component | 2-component | MIR@85 C. | Gas Ratio |
| Pilot | I | Cat-1 | 100 | 100 | | 0.0039 |
| Pilot | II | Cat-2 | 71 | 67 | | 0.0028 |
| Pilot | III | Cat-3 | 54 | 51 | | 0.0021 |
| Pilot | IV | Cat-4 | 49 | 44 | 21.5 | 0.0017 |
| Pilot | IV | Cat-5 | 48 | 44 | 20.1 | |
| Pilot | V | Cat-6 | 44 | 40 | 24.8 | 0.0013 |
| Pilot | VI | Cat-7 | 36 | 33 | | 0.0010 |
| Pilot | VII | Cat-8 | 0 | 0 | | 0.0004 |
| Comm | II | B-1 | 83 | 77 | 17.8 | 0.0030 |
| Comm | IV | B-4 | 53 | 48 | 19.2 | 0.0022 |
| Comm | IV | B-5 | 58 | 52 | 20.0 | 0.0019 |
| Comm | IV | B-6 | 47 | 44 | 21.1 | 0.0020 |
| Comm | IV | B-7 | 48 | 47 | 21.4 | 0.0018 |
| Comm | IV | B-8 | 50 | 46 | 21.4 | 0.0017 |
| Comm | IV | B-9 | 49 | 43 | 23.1 | 0.0015 |
| Comm | IV | B-10 | 45 | 40 | 23.1 | 0.0017 |
| Comm | IV | B-11 | 48 | 44 | | 0.0015 |
| Comm | IV | B-12 | 45 | 40 | | 0.0018 |
| Comm | IV | B-13 | 44 | 38 | 23.4 | 0.0019 |
| Comm | IV | B-14 | 49 | 43 | | 0.0017 |
| Comm | IV | B-15 | 51 | 46 | 19.7 | 0.0023 |
| Comm | IV | B-16 | 44 | 36 | | 0.0020 |
| Comm | IV | B-17 | 49 | 43 | | 0.0020 |
| Comm | IV | B-18 | 47 | 42 | | 0.0023 |
| Comm | IV | B-19 | 47 | 42 | | 0.0019 |
| Comm | IV | B-20 | 47 | 42 | | 0.0019 |
| Comm | IV | B-21 | 49 | 43 | | 0.0020 |

FIG. 9B shows the mol % of precursor A used in the preparation of dual-component catalyst versus the % of spectrum of Cat-1 (activated precursor A) from Table 2. The dashed line represents when the mol % of precursor A is equal to the % of spectrum of Cat-1 (activated precursor A), which is true only when Equation 1 is satisfied.

$$\frac{Activation Efficiency precursor A}{Activation Efficiency precursor B} * \frac{{ε}_{Activated precursor A}}{{ε}_{Activated precursor B}} = 1 \qquad Equation 1$$

### Example 3

For a dual-component catalyst consisting both activated precursor A and activated precursor B, the relative contribution of the two different types of active sites in a polymerization reaction can be quantified via two methods. The first is to analyze the melt index ratio (MIR) of polymer resin made in a pilot plant testing using the given catalyst at 85° C. reactor temperature under fixed H2 concentration and fixed 1-hexene/ethylene feed rate ratio. The higher the contribution of activated precursor A in polymerization, the narrower the molecular weight distribution of the polymer becomes, leading to lower MIR value. The second method is to analyze the H2/ethylene mol ratio in gas phase, at the end of a 1-hr run in a lab batch reactor under fixed reactor run condition. Under the chosen run condition, activated precursor A sites generate H2 gas during polymerization, whereas activated precursor B sites consume H2 during polymerization. The higher the contribution of activated precursor A in polymerization, the more H2 is generated during the 1-hr run, leading to higher end-of-run H2/ethylene gas ratio at 1 h timestamp of a polymerization run. Two set of polymerization test results for catalysts in Table 1 are listed in Table 2, namely the observed MIR values from pilot plant testing, and the end-of-run H2/ethylene mol ratio in gas phase from a lab batch reactor testing.

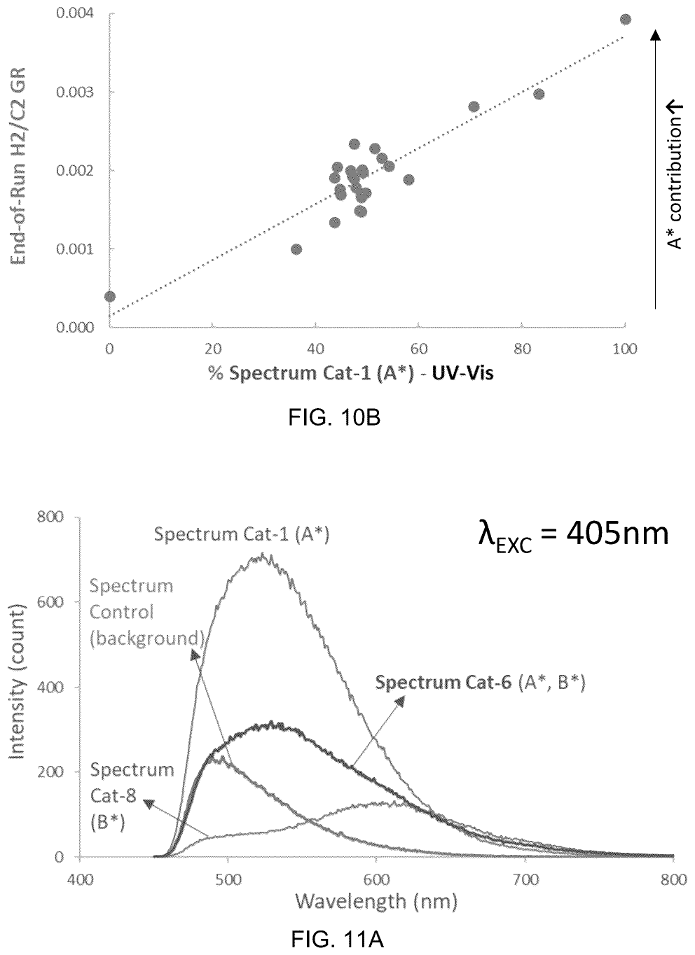

FIG. 10A is a graph of the % spectrum of Cat-1 (activated precursor A) derived from UV-Vis deconvolution vs. the resin MIR observed in the pilot plant testing of the corresponding catalyst. FIG. 10B is a graph of the % spectrum of Cat-1 (activated precursor A) derived from UV-Vis deconvolution vs. the end-of-run H2/ethylene ratio in gas phase from a lab batch reactor testing of the corresponding catalyst. The good to excellent correlations in FIG. 10A and FIG. 10B suggest that the % spectrum of Cat-1 (activated precursor A) derived from UV-Vis deconvolution of a given dual-component catalyst can serve to predict the % contribution of activated precursor A in the polymerization reaction for the dual-component catalyst.

### Example 4

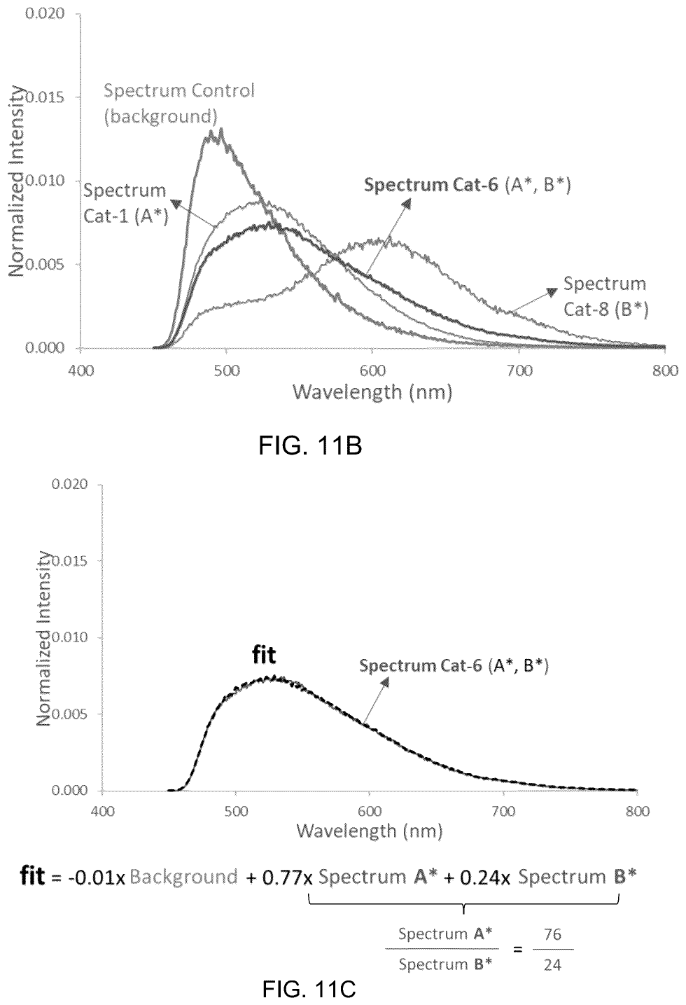

In this example steady-state emission spectra (SS-EMS) for supported catalyst was obtained using the same cuvette sample used in UV-Vis measurement in Example 1. In SS-EMS measurement, an excitation light of selected wavelength (e.g. 405 nm or 485 nm) was directed at the settled solids. The angle between the excitation light and the cuvette wall was kept at ˜60° angle. The steady-state emission was recorded at the detector located in front of the cuvette. A long-pass filter is placed was front of the detector to prevent scattered excitation light from reaching the detector. The observation wavelength range of the steady-state emission can be customized by using different long-pass filter (e.g. observation range of 450-800 nm when using 405 nm excitation light). FIG. 11A is the as-measured SS-EMS spectra (using 405 nm excitation light) of the control (prepared with no metallocene precursor), Cat-1 (prepared with 100/0 precursor ratio), Cat-8 (prepared with 0/100 precursor ratio), and Cat-6 (prepared with 50/50 precursor ratio). FIG. 11B is the normalized spectra of the four spectra in FIG. 11A where the area under the curve between 450-800 nm equals 1.

Similar to the 3-component fitting method described above for the linear deconvolution of normalized UV-Vis spectrum, the normalized SS-EMS spectrum of a dual-component catalyst can be mathematically fitted by a linear combination of the normalized control spectrum (background), the normalized spectrum of Cat-1 (single-component activated precursor A), and the normalized spectrum of Cat-8 (single-component activated precursor B). FIG. 11C shows that the normalized spectrum of Cat-6 is best described by a combination of 76% the normalized spectrum of Cat-1 (single-component activated precursor A) and 24% the normalized spectrum of Cat-8 (single-component activated precursor B). The above fitting protocol can also be performed on raw (as-measured) SS-EMS spectra, though an adequate correction factor may need to be applied.

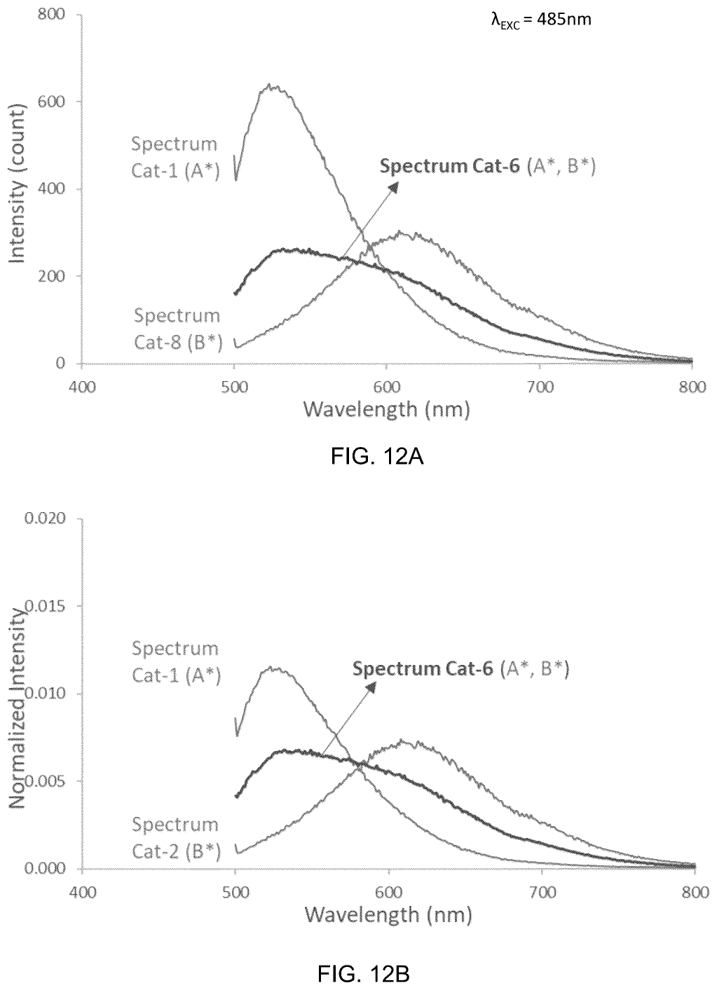

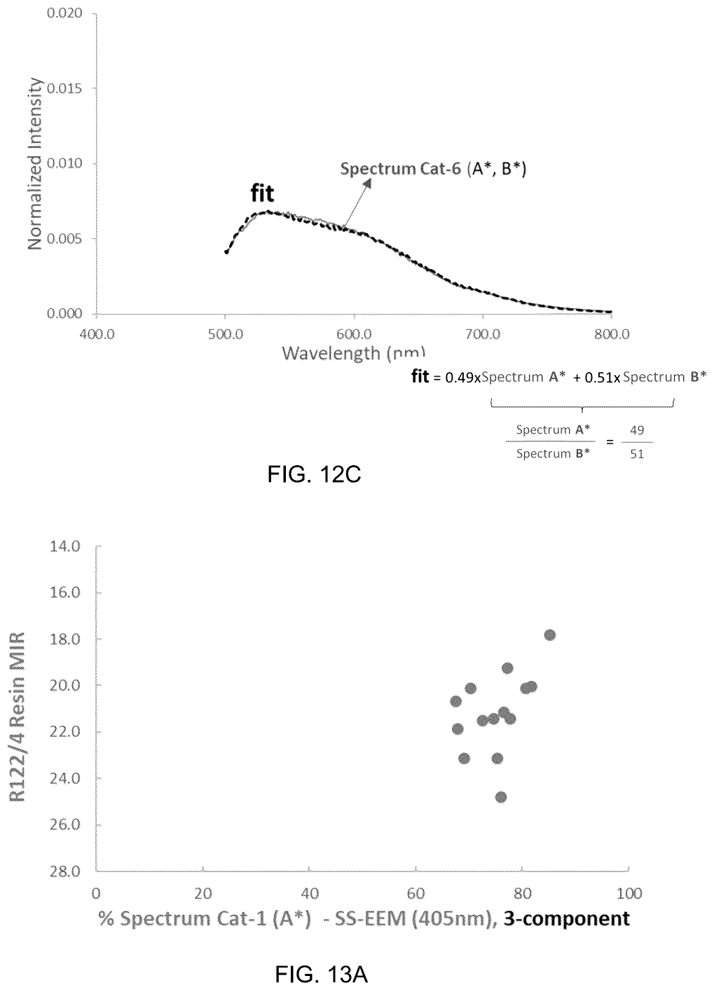

FIG. 12A is the as-measured SS-EMS spectra (using 485 nm excitation light) of Cat-1 (prepared with 100/0 precursor ratio), Cat-8 (prepared with 0/100 precursor ratio), and Cat-6 (prepared with 50/50 precursor ratio). FIG. 12B is the normalized spectra of the three spectra in FIG. 12A where the area under the curve between 500-800 nm equals 1. Similar to the 2-component fitting method described above for the linear deconvolution of normalized UV-Vis spectrum, the normalized SS-EMS spectrum of a dual-component catalyst can be mathematically fitted by a linear combination of the normalized spectrum of Cat-1 (single-component activated precursor A), and the normalized spectrum of Cat-8 (single-component activated precursor B). FIG. 12C shows that the normalized spectrum of Cat-6 is best described by a combination of 49% the normalized spectrum of Cat-1 (single-component activated precursor A) and 51% the normalized spectrum of Cat-8 (single-component activated precursor B). The above fitting protocol can also be performed on raw (as-measured) SS-EMS spectra, though an adequate correction factor may need to be applied.

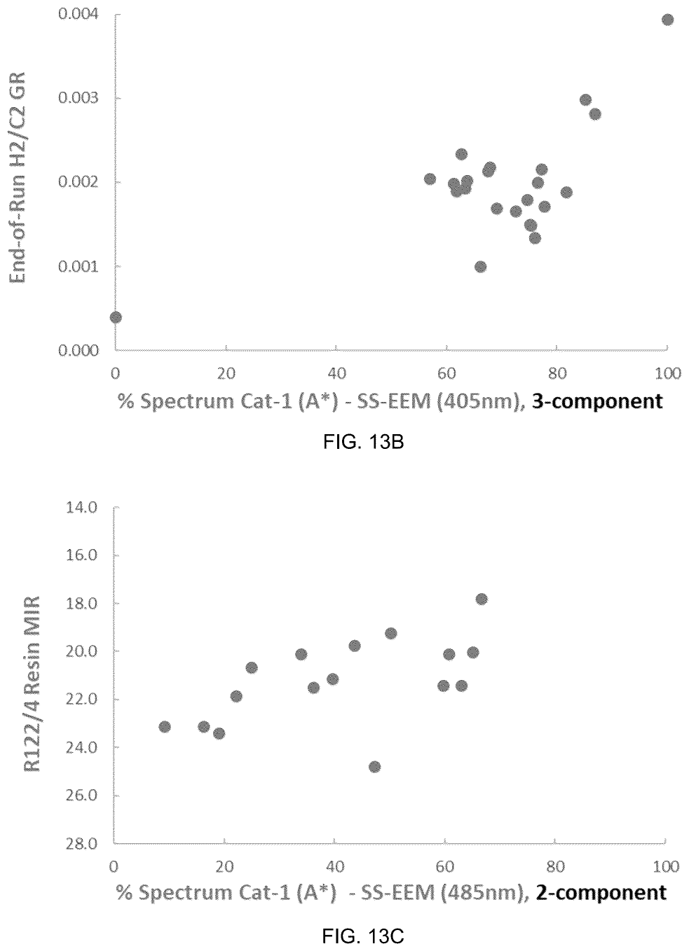

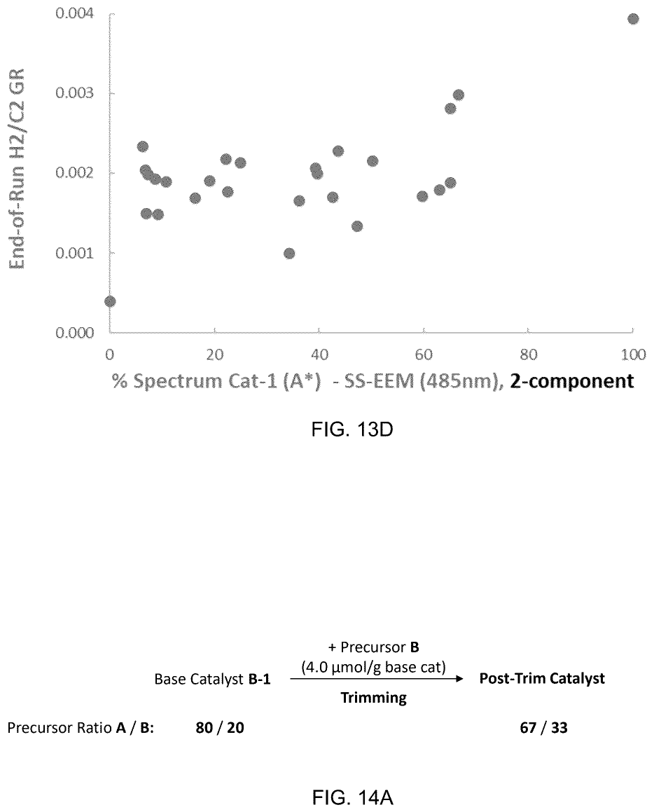

The 3-component fitting method was applied to the spectral deconvolution of the SS-EMS spectra obtained with 405 nm excitation light for catalysts from Table 1. The 2-component fitting method was applied to the spectral deconvolution of the SS-EMS spectra obtained with 405 nm excitation light for catalysts from Table 1. The results from the two deconvolution methods are shown in Table 3. FIG. 13A is a graph of the % spectrum of Cat-1 (activated precursor A) derived from SS-EMS deconvolution (405 nm excitation, 3-component fitting) vs. the resin MIR observed in the pilot plant testing of the corresponding catalyst. FIG. 13B is a graph of the % spectrum of Cat-1 (activated precursor A) derived from SS-EMS deconvolution (405 nm excitation, 3-component fitting) vs. the end-of-run H2/ethylene ratio in gas phase from a lab batch reactor testing of the corresponding catalyst. FIG. 13C is a graph of the % spectrum of Cat-1 (activated precursor A) derived from SS-EMS deconvolution (485 nm excitation, 2-component fitting) vs. the resin MIR observed in the pilot plant testing of the corresponding catalyst. FIG. 13D is a graph of the % spectrum of Cat-1 (activated precursor A) derived from SS-EMS deconvolution (485 nm excitation, 2-component fitting) vs. the end-of-run H2/ethylene ratio in gas phase from a lab batch reactor testing of the corresponding catalyst. Reasonable correlations are observed in FIG. 13A-D, though they appear to be noisier than the correlations seen with UV-Vis derived deconvolution results in FIG. 10A-B. The SS-EMS based deconvolution serves as a secondary quantification method (in addition to UV-Vis) for quantifying the active site composition on supported dual-component catalyst.

TABLE 3
Result

| | | | SS-EMS Spectral Deconvolution | | Polymerization Testing | |
|---|---|---|---|---|---|---|
| | | | % Spectrum | % Spectrum | | Lab batch |
| | | | Cat-1 (A*) | Cat-1 (A*) | Result | Reactor: End- |
| Prep | | Catalyst | 405 nm Exc, | 485 nm Exc, | Pilot Plant: | of-run H2/C2 |
| Scale | Formulation | ID | 3-component | 2-component | MIR@85 C. | Gas Ratio |
| Pilot | I | Cat-1 | 100 | 100 | | 0.0039 |
| Pilot | II | Cat-2 | 87 | 65 | | 0.0028 |
| Pilot | III | Cat-3 | | 39 | | 0.0021 |
| Pilot | IV | Cat-4 | 73 | 36 | 21.5 | 0.0017 |
| Pilot | IV | Cat-5 | 70 | 34 | 20.1 | |
| Pilot | V | Cat-6 | 76 | 47 | 24.8 | 0.0013 |
| Pilot | VI | Cat-7 | 66 | 34 | | 0.0010 |
| Pilot | VII | Cat-8 | 0 | 0 | | 0.0004 |
| Comm | II | B-1 | 85 | 67 | 17.8 | 0.0030 |
| Comm | IV | B-4 | 77 | 50 | 19.2 | 0.0022 |
| Comm | IV | B-5 | 82 | 65 | 20.0 | 0.0019 |
| Comm | IV | B-6 | 76 | 40 | 21.1 | 0.0020 |
| Comm | IV | B-7 | 75 | 63 | 21.4 | 0.0018 |
| Comm | IV | B-8 | 78 | 60 | 21.4 | 0.0017 |
| Comm | IV | B-9 | 75 | 9 | 23.1 | 0.0015 |
| Comm | IV | B-10 | 69 | 16 | 23.1 | 0.0017 |
| Comm | IV | B-11 | 75 | 7 | | 0.0015 |
| Comm | IV | B-12 | | 23 | | 0.0018 |
| Comm | IV | B-13 | | 19 | 23.4 | 0.0019 |
| Comm | IV | B-14 | | 42 | | 0.0017 |
| Comm | IV | B-15 | | 44 | 19.7 | 0.0023 |
| Comm | IV | B-16 | 57 | 7 | | 0.0020 |
| Comm | IV | B-17 | 61 | 7 | | 0.0020 |
| Comm | IV | B-18 | 63 | 6 | | 0.0023 |
| Comm | IV | B-19 | 63 | 9 | | 0.0019 |
| Comm | IV | B-20 | 62 | 11 | | 0.0019 |
| Comm | IV | B-21 | 64 | | | 0.0020 |

### Example 5

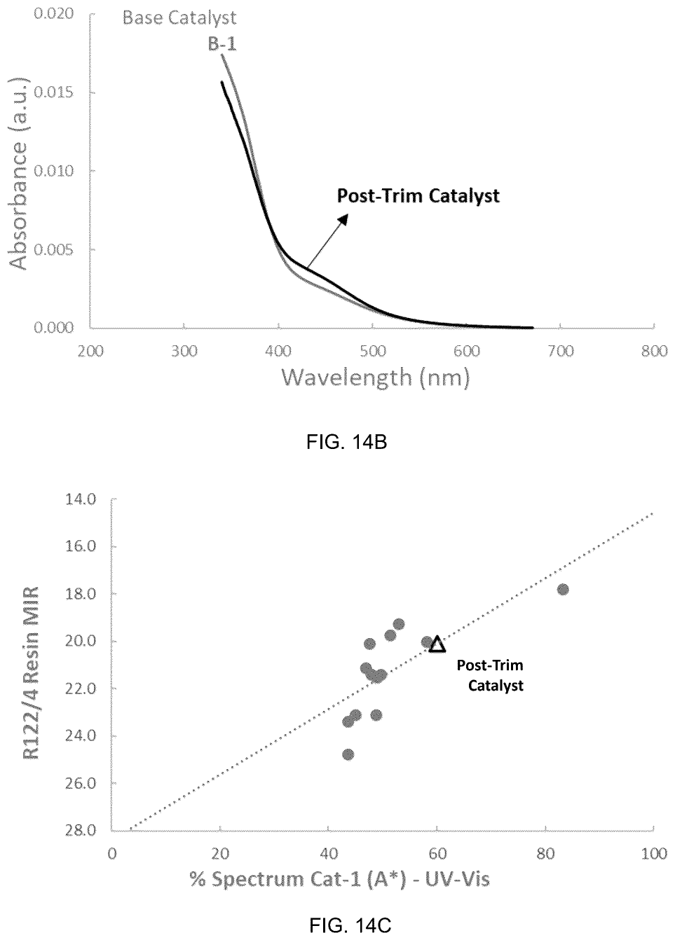

In this example, the spectral deconvolution methods developed above were utilized to evaluate post-trim dual-component catalyst. Catalyst B-1 from Table 1 above was trimmed with precursor B. FIG. 14A shows that the trimming process changes the precursor ratio from 80/20 in base catalyst to 67/33 in post-trim catalyst. The UV-Vis absorption spectrum of catalyst B-1 and the post-trim catalyst were obtained and normalized following the protocols outlined in the above examples. The normalized UV-Vis spectrum of catalyst B-1 and the post-trim catalyst are shown in FIG. 14B.

The 3-component spectral deconvolution protocols outlined above for UV-Vis spectra was performed with the normalized UV-Vis spectrum of the post-trim catalyst. The normalized UV-Vis spectrum of the post-trim catalyst is best described by a combination of 60% the normalized spectrum of Cat-1 (single-component activated precursor A) and 40% the normalized spectrum of Cat-8 (single-component activated precursor B). The triangle in FIG. 14C shows % spectrum of Cat-1 (activated precursor A) derived from UV-Vis deconvolution of the post-trim catalyst vs. the resin MIR observed in the pilot plant testing of the post-trim catalyst. It was observed from FIG. 14C that the post-trim catalyst's result appear to be consistent in trend when compared to data series consisting only base catalysts.

### Example 6

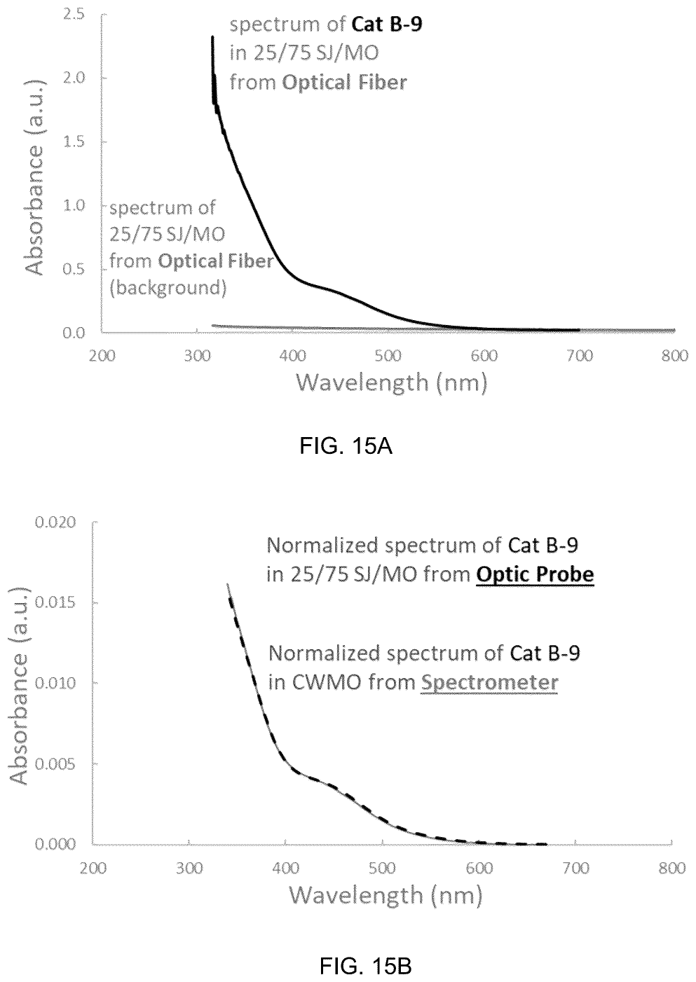

To mimic the composition of a commercial slurry containing dual-component catalyst, catalyst B-9 (prepared with 60/40 precursor ratio) from Table 1 was slurried in a mineral oil diluent that consists of 25 wt % of Sonneborn SonoJell® and 75 wt % of HB380 Mineral oil (represented as 25/75 SJ/MO). The resulting slurry sample was placed in a 1 mm×10 mm cuvette, and the UV-Vis measurement was carried out using an optical probe with the diluent 25/75 SJ/MO as the background. The optical probe was constructed by coupling two optic fibers to the light source and the detector of a spectrometer respectively (Duetta, Horiba Inc). The distance in-between the two fiber ends was set to 1 mm to accommodate a 1 mm×10 mm cuvette. FIG. 15A is the as measured UV-Vis spectra of catalyst B-9 in 25/75 SJ/MO, and the as measured spectra of the diluent 25/70 SJ/MO. Background correction and spectral normalization were applied to the as measured spectrum of catalyst B-9 according to the method described above. FIG. 15B is the normalized UV-Vis spectrum of catalyst B-9 obtained with the optic probe and a normalized UV-Vis spectrum of catalyst B-9 obtained from a standard spectrometer. It was observed in FIG. 15B that the normalized spectrum from optic probe prototype is equivalent to the normalized spectrum from a standard spectrometer. The excellent consistency between the two normalized spectra indicates that the optical probe yields functionally equivalent spectra for spectral deconvolution purpose, hence validating the probe design for in-line monitoring of catalyst composition.

### Example 7

In this example, a prototype optical probe capable of SS-EMS measurement was constructed according to the design in FIG. 6B. This optical probe can be used to acquire SS-EMS in front face configuration, in which the angle between the excitation light and the cuvette wall was kept at 90° angle. This optical probe can also be used to acquire SS-EMS by immersing the optical probe inside the sample, where the size of the optical path is regulated by movable light blocker 622. A long-pass filter is placed in front of the detector to prevent reflected excitation light from reaching the detector. The observation wavelength range of the steady-state emission can be customized by using different long-pass filter (e.g. observation range of 500-800 nm when using 480 nm excitation light). An optional short-pass filter can be placed in front of the laser light source (e.g. 500 nm short-pass filter when using 480 nm excitation light).

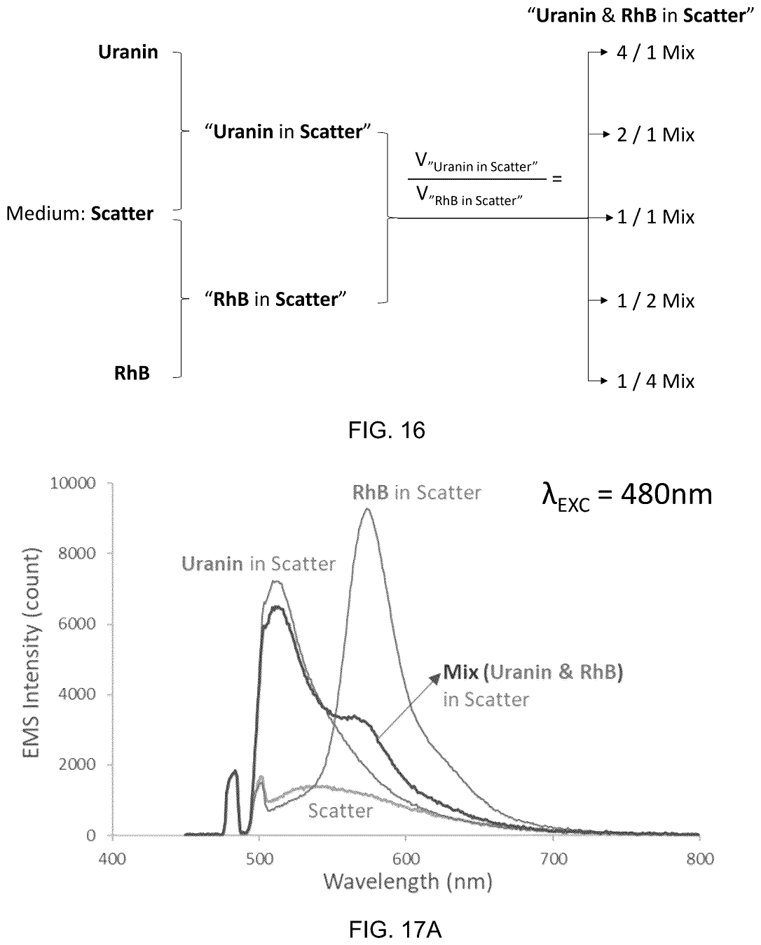

A series of control samples were prepared by the combination of an aqueous scatter medium and two organic dyes Uranin and RhB. FIG. 16 shows that two 2-component mixtures were created first, namely “Uranin in Scatter” and “RhB in Scatter”. By mixing the two 2-component mixtures in different volume ratio, five 3-component mixtures were subsequently created. The aqueous scatter medium, the two 2-component mixtures, and the five 3-component mixtures were used as the sample set for SS-EMS optical probe validation described below.

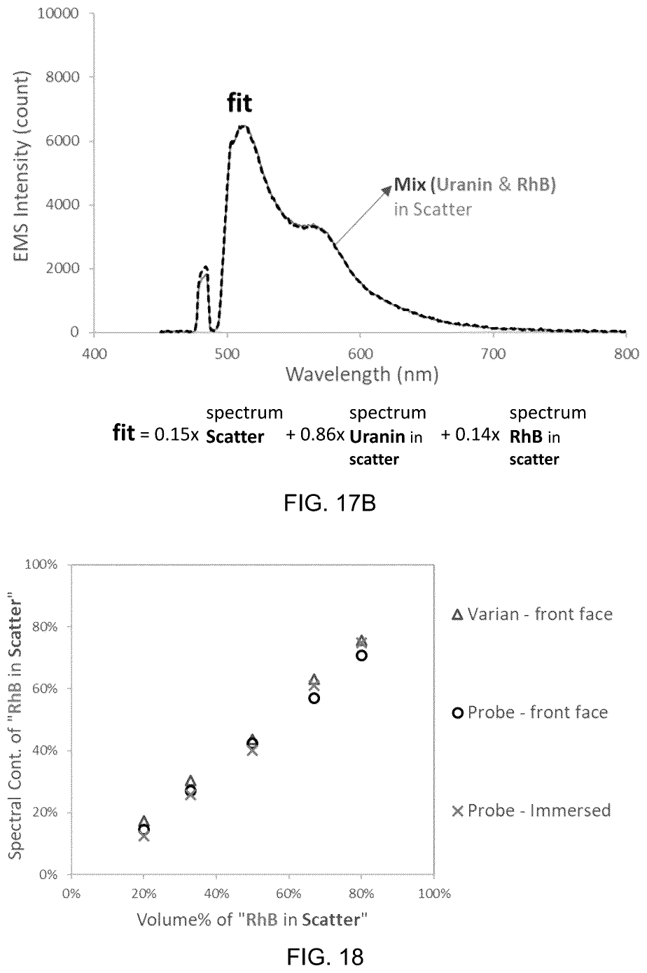

The SS-EMS for the 8 control samples described above were measured with 480 nm excitation under three different configurations: 1) front face configuration on Varian spectrometer; 2) front face configuration with the SS-EMS optical probe described above; and 3) immersed in sample with the SS-EMS optical probe described above. FIG. 17A shows the as-measured steady-state emission spectra from front face configuration with the optical probe of the scatter medium, “Uranin in Scatter”, “RhB in Scatter”, and a mixture of “Uranin and RhB in Scatter”. The as-measured emission spectrum of the mixture of “Uranin and RhB in Scatter” can be mathematically fitted using three components, namely the as-measured emission spectrum of the scatter medium, the as-measured emission spectrum of “Uranin in Scatter”, and the as-measured emission spectrum of “RhB in Scatter”. FIG. 17B shows that the as-measured emission spectrum of the mixture of “Uranin and RhB in Scatter” is best described by a combination of 86% as-measured spectrum of “Uranin in Scatter” and 14% as measured spectrum of “RhB in Scatter”.

The spectral deconvolution protocol described above was applied to the as-measured SS-EMS of the control samples obtained from the three different measurement configurations described above. FIG. 18 shows the % spectrum of “RhB in Scatter” of the “Uranin and RhB in Scatter” derived from the spectral deconvolution versus the vol % of “RhB in Scatter” in the “Uranin and RhB in Scatter”. The excellent consistency among the three measurement configurations suggests that the SS-EMS optical probe yields functionally equivalent spectral deconvolution results to standard spectrometer.

### Example 8

In this example, a prototype optical probe capable of time-resolved emission measurement was constructed according to the design in FIG. 6B. A 440 nm pulsed laser was used as the excitation light source, and the intensity decay of the emission was detected by a fluorescence spectrometer model FluoTime 300 from PicoQuart. This optical probe can be used to acquire emission intensity decay in front face configuration, in which the angle between the excitation light and the cuvette wall was kept at 90° angle.

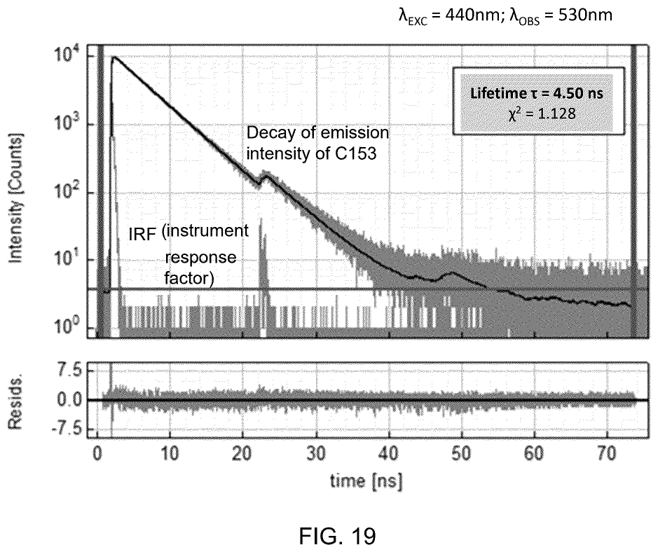

FIG. 19 is the decay of the fluorescence emission intensity at 530 nm of C₁₅₃ dye obtained with the optical probe described above. After correcting for instrument response factor (IRF), the decay curve can be fitted with a single-component exponential decay, yielding an intensity-weighted average fluorescence lifetime of 4.50 ns, which is in excellent agreement with the 4.43 ns lifetime of C₁₅₃ dye obtained on standard spectrometer (i.e. FluoTime 300, PicoQuant).

While the disclosure has been described with respect to a number of embodiments and examples, those skilled in the art, having benefit of this disclosure, will appreciate that other embodiments can be devised which do not depart from the scope and spirit of the disclosure as disclosed herein. Although individual embodiments are discussed, the present disclosure covers all combinations of all those embodiments.

While compositions, methods, and processes are described herein in terms of “comprising,” “containing,” “having,” or “including” various components or steps, the compositions and methods can also “consist essentially of” or “consist of” the various components and steps. The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the disclosure, additionally, they do not exclude impurities and variances normally associated with the elements and materials used.

All numerical values within the detailed description are modified by “about” the indicated value, and take into account experimental error and variations that would be expected by a person having ordinary skill in the art.

Many alterations, modifications, and variations will be apparent to those skilled in the art in light of the foregoing description without departing from the spirit or scope of the present disclosure and that when numerical lower limits and numerical upper limits are listed herein, ranges from any lower limit to any upper limit are contemplated.

1. A method comprising:
preparing a slurry catalyst mixture comprising a multi-modal catalyst and a carrier fluid, wherein the multi-modal catalyst comprises a first activated catalyst and a second activated catalyst;
introducing the slurry catalyst mixture into a sample chamber;
illuminating the slurry catalyst mixture in the sample chamber with light generated from a light source;
capturing a spectrum of the slurry catalyst mixture using a detector, wherein the spectrum comprises at least one spectrum selected from the group consisting of UV-Vis spectrum, emission spectrum, and combinations thereof; and
determining a calculated ratio of an amount of the first activated catalyst and an amount of the second activated catalyst in the multi-modal catalyst from the spectrum of the slurry catalyst mixture by fitting the spectrum of the slurry catalyst mixture to a single component spectrum of the first activated catalyst and a single component spectrum of the second activated catalyst, using spectral deconvolution.

2. The method of claim 1, wherein the slurry catalyst mixture further comprises a third activated catalyst and/or a fourth activated catalyst, and wherein the method further comprises fitting the spectrum of the slurry catalyst mixture to a single component spectrum of the third activated catalyst and/or a single component spectrum of the fourth activated catalyst, using spectral deconvolution.

3. The method of claim 1 wherein the light source outputs light from 200-900 nm and wherein the detector is configured to capture the UV-Vis spectrum.

4. The method of claim 1 wherein the light source comprises a laser and the detector is configured to capture the emission spectrum.

5. The method of claim 1 wherein the light source comprises a pulsed light source or intensity modulated light source and wherein the spectrum comprises a time-resolved response of fluorescence and/or phosphorescence lifetimes of the catalyst slurry mixture.

6. The method of claim 1 further comprising one or more of subtracting background contribution from the spectrum, subtracting scattering contribution from the spectrum, or normalizing the spectrum, to form a modified spectrum wherein the modified spectrum is used in the spectral deconvolution.

7. The method of claim 1 wherein the slurry catalyst mixture comprises a contact product of a first catalyst, a second catalyst, a support, an activator, and the carrier fluid,
wherein the support comprises silica,
wherein the activator comprises an aluminoxane,
wherein the carrier fluid comprises mineral oil or mixture of mineral oils,
wherein the first catalyst and the second catalyst each comprise a metallocene or a non-metallocene catalyst, and,
wherein the activator activates at least a portion of the first catalyst to produce the first activated catalyst and wherein the activator activates at least a portion of the second catalyst to produce the second activated catalyst.

8. The method of claim 7 wherein the first catalyst comprises a bridged bis-cyclopentadienyl hafnocene, and wherein the second catalyst comprises an unbridged indenyl-cyclopentadienyl zirconocene.

9. A method comprising:
providing an optical probe, the optical probe comprising a light source, a detector, and an optic fiber, wherein the optic fiber is configured to transmit light emitted from the light source to a sample chamber and wherein the optic fiber is further configured to transmit light from the sample chamber to the detector;
preparing a slurry catalyst mixture comprising a multi-modal catalyst and a carrier fluid, wherein the multi-modal catalyst comprises a first activated catalyst and a second activated catalyst;
continuously feeding the slurry catalyst mixture into the sample chamber;
illuminating the slurry catalyst mixture in the sample chamber with light generated from the light source, while continuously feeding the slurry catalyst mixture into the sample chamber;
capturing a spectrum of the continuously fed slurry catalyst mixture using a detector, wherein the spectrum comprises at least one spectrum selected from the group consisting of UV-Vis spectrum, emission spectrum, and combinations thereof; and
determining a calculated ratio of an amount of the first activated catalyst and an amount of the second activated catalyst in the multi-modal catalyst from the spectrum of the slurry catalyst mixture by fitting the spectrum of the slurry catalyst mixture to a single component spectrum of the first activated catalyst and a single component spectrum of the second activated catalyst, using spectral deconvolution.

10. The method of claim 9 wherein the slurry catalyst mixture further comprises a third activated catalyst and/or a fourth activated catalyst, and wherein the method further comprises fitting the spectrum of the slurry catalyst mixture to a single component spectrum of the third activated catalyst and/or a single component spectrum of the fourth activated catalyst, using spectral deconvolution.

11. The method of claim 9 wherein the light source outputs light from 200-900 nm and wherein the detector is configured to capture the UV-Vis spectrum.

12. The method of claim 9 wherein the light source comprises a laser and the detector is configured to capture the emission spectrum.

13. The method of claim 9 wherein the light source comprises a pulsed light source or intensity modulated light source and wherein the spectrum comprise a time-resolved response of fluorescence and/or phosphorescence lifetimes of the catalyst slurry mixture.

14. The method of claim 9 further comprising at least one of subtracting background contribution from the spectrum, subtracting scattering contribution from the spectrum, or normalizing the spectrum, to form a modified spectrum wherein the modified spectrum is used in the spectral deconvolution.

15. The method of claim 9 wherein the slurry catalyst mixture comprises a contact product of a first catalyst, a second catalyst, a support, an activator, and the carrier fluid,
wherein the support comprises silica,
wherein the activator comprises an aluminoxane,
wherein the carrier fluid comprises mineral oil or mixture of mineral oils,
wherein the first catalyst and the second catalyst each comprise a metallocene or a non-metallocene catalyst, and,
wherein the activator activates at least a portion of the first catalyst to produce the first activated catalyst and wherein the activator activates at least a portion of the second catalyst to produce the second activated catalyst.

16. The method of claim 16 wherein the first catalyst comprises a bridged bis-cyclopentadienyl hafnocene, and wherein the second catalyst comprises an unbridged indenyl-cyclopentadienyl zirconocene.

17. A method comprising:
contacting a base catalyst mixture and a trim catalyst solution to form a contact product comprising a post-trim multimodal catalyst, wherein the base catalyst mixture comprises a first catalyst, a second catalyst, a support, an activator, and a carrier, wherein the trim catalyst solution comprises additional second catalyst, and a solvent, and wherein the post-trim bimodal catalyst comprises a first active catalyst corresponding to the first catalyst and a second active catalyst corresponding to the second catalyst;
generating a spectrum of the post-trim multimodal catalyst;
determining a calculated ratio of an amount of the first active catalyst and the second active catalyst in the post-trim multimodal catalyst from the spectrum of the post-trim multimodal catalyst by fitting the spectrum of the post-trim multimodal catalyst to a single component spectrum of the first active catalyst and a single component spectrum of the second active catalyst using spectral deconvolution;
comparing the calculated ratio to a target ratio of the first active catalyst and the second active catalyst in the post-trim multimodal catalyst and adjusting a flow rate of the trim catalyst solution such that the calculated ratio of amount of the first active catalyst and the second active catalyst in the post-trim multimodal catalyst is closer to the target ratio;
introducing the post-trim multimodal catalyst and one or more olefins into a polymerization reactor; and
polymerizing the one or more olefins in the presence of the post-trim multimodal catalyst to produce a polymer product.

18. The method of claim 17 wherein the support comprises silica, wherein the activator comprises an aluminoxane, wherein the first catalyst and the second catalyst each comprise a metallocene or a non-metallocene catalyst.

19. The method of claim 17 wherein the spectrum comprises a UV-Vis spectrum and wherein generating the spectrum comprises illuminating the post-trim multimodal catalyst with a light source which outputs light from 200-900 nm.

20. The method of claim 17 wherein the spectrum comprises an emission spectrum and wherein generating the spectrum comprises illuminating the post-trim multimodal catalyst with a laser.

21. The method of claim 20 wherein the laser comprises a pulsed laser light source or intensity modulated laser light source and wherein the spectral deconvolution comprises calculating a time-resolved response and/or a time-gated response of fluorescence and/or phosphorescence lifetimes of the post-trim multimodal catalyst.

22. The method of claim 17 wherein the calculated ratio of the amount of the first active catalyst and the second active catalyst in the post-trim multimodal catalyst is determined from the time-resolved and/or the time-gated response of the post-trim multimodal catalyst by fitting emission spectrum lifetimes and/or time-resolved spectra of the post-trim multimodal catalyst to a single component spectrum response of the first active catalyst and a single component spectrum response of the second active catalyst.

23. The method of claim 17 wherein the first catalyst comprises a bridged bis-cyclopentadienyl hafnocene, and wherein the second catalyst comprises an unbridged indenyl-cyclopentadienyl zirconocene.

24. The method of claim 17 further comprising one or more of subtracting background contribution from the spectrum, subtracting scattering contribution from the spectrum, or normalizing the spectrum, to form a modified spectrum wherein the modified spectrum is used in the spectral deconvolution.

25. The method of claim 17 wherein the contacting the base catalyst mixture and the trim catalyst solution occurs in a process feedline downstream from a tie-in point of the base catalyst mixture and the trim catalyst solution, to produce the post-trim multimodal catalyst on a continuous basis; and further wherein the spectrum of the post-trim multimodal catalyst is generated from the continuously flowing post-trim multimodal catalyst.

26. The method of claim 17 wherein the contacting the base catalyst mixture and the trim catalyst solution takes place in a mixer fluidically coupled to a trim pot comprising the trim catalyst solution and a base catalyst mixture pot comprising the base catalyst mixture, wherein the mixer is configured to mix the base catalyst mixture and the trim catalyst solution to produce the post-trim multimodal catalyst.

27. A system comprising:
a sample chamber configured to hold a post-trim multimodal catalyst mixture, wherein the post-trim multimodal catalyst mixture comprises a first activated catalyst and a second activated catalyst, wherein the post-trim multimodal catalyst mixture is produced by contacting a base catalyst mixture and a trim catalyst solution to form a contact product comprising a post-trim multimodal catalyst, wherein the base catalyst mixture comprises a first catalyst, a second catalyst, a support, an activator, and a carrier, wherein the trim catalyst solution comprises additional second catalyst, and a solvent, and wherein the post-trim bimodal catalyst comprises a first active catalyst corresponding to the first catalyst and a second active catalyst corresponding to the second catalyst;
an optical probe configured to illuminate the post-trim multimodal catalyst mixture in the sample chamber and generate a spectrum of the post-trim multimodal catalyst mixture; and
a control system configured to:
receive the spectrum;
determine a calculated ratio of an amount of the first activated catalyst and the second activated catalyst in the post-trim multimodal catalyst mixture from the spectrum of the post-trim multimodal catalyst mixture by fitting the spectrum of the post-trim multimodal catalyst mixture to a single component spectrum of the first activated catalyst and a single component spectrum of the second activated catalyst using spectral deconvolution;
compare the calculated ratio of the amount of the first activated catalyst and the second activated catalyst in the multimodal catalyst to a set point ratio of the amount of the first activated catalyst and the second activated catalyst in the multimodal catalyst; and
adjust a flow rate of a trim catalyst solution such that the calculated ratio of amount of the first active catalyst and the second active catalyst in the post-trim multimodal catalyst is closer to the set point ratio.

28. The system of claim 27 wherein the control system is further configured to perform one or more of subtracting background contribution from the spectrum, subtracting scattering contribution from the spectrum, or normalizing the spectrum, to form a modified spectrum wherein the modified is used in the spectral deconvolution.

29. The system of claim 27 wherein the optical probe outputs light from 200-900 nm and wherein the spectrum is a UV-Vis spectrum.

30. The system of claim 27 wherein the optical probe comprises a laser and wherein the spectrum is an emission spectrum.

31. The system of claim 27 wherein the optical probe comprises a pulsed light source or intensity modulated light source and wherein the spectrum comprises a time-resolved response of fluorescence and/or phosphorescence lifetimes of the post-trim multimodal catalyst.

32. The system of claim 27 wherein the post-trim multimodal catalyst comprises a support comprising silica, an activator comprising an aluminoxane, and two metallocene catalysts.

33. The system of claim 32 wherein the two metallocene catalysts comprise a bridged bis-cyclopentadienyl hafnocene and an unbridged indenyl-cyclopentadienyl zirconocene.
